(19) United States
(12) Patent Application Publication
(10) Pub. No.: US 2026/0246381 A1
(43) Pub. Date: Aug. 20, 2026

(54) NEGATIVE VOLTAGE GENERATOR, OPERATION METHOD THEREOF AND ELECTRONIC DEVICE INCLUDING THE SAME

(71) Applicant: SAMSUNG ELECTRONICS CO., LTD., Suwon-si (KR)

(72) Inventors: SANGKWON LEE, Suwon-si (KR); HEEJONG KIM, Suwon-si (KR); SUNG JIN PARK, Suwon-si (KR); SANGWOO BAE, Suwon-si (KR); YUNRAE JO, Suwon-si (KR)

(73) Assignee: SAMSUNG ELECTRONICS CO., LTD., Suwon-si (KR)

(21) Appl. No.: 19/453,660

(22) Filed: Jan. 20, 2026

(30) Foreign Application Priority Data
Feb. 20, 2025 (KR) 10-2025-0022368
May 21, 2025 (KR) 10-2025-0066226

(51) Int. Cl. H02M 3/07; G09G 3/20; G09G 3/32

(52) U.S. Cl. CPC H02M 3/071; G09G 3/2092; G09G 3/32; G09G 2330/026

(57) ABSTRACT

A voltage generator is provided. The generator includes: a first stage circuit and a second stage circuit. The second stage circuit includes: a first start-up switch configured to connect the second input node and a first node; a second start-up switch configured to connect a ground node and a second node; a first switch configured to connect the third input node and the first node; a second switch configured to connect the first node and the ground node; a third switch configured to connect the second node and the first output node; a fourth switch configured to connect the second node and the second output node; and a first capacitor connected between the first node and the second node.

### CROSS-REFERENCE TO RELATED APPLICATIONS

This application claims priority under 35 U.S.C § 119 to Korean Patent Application No. 10-2025-0022368 filed on February 20, 2025, and Korean Patent Application No. 10-2025-0066226 filed on May 21, 2025, in the Korean Intellectual Property Office, the disclosures of which are incorporated by reference herein in their entireties.

### BACKGROUND

The present disclosure relates to a semiconductor device including a voltage generator, and more specifically related to a negative voltage generator, an operating method thereof, and an electronic device including the same.

A voltage having a negative voltage level may be used in operation of a display device. For example, a display driver integrated circuit (IC) (DDI) may generate a negative voltage used by a display panel, and the display panel may operate using the negative voltage. The negative voltage generator may be implemented as a charge pump.

The negative voltage generator may include a plurality of transistors for operation, and the voltage generated by the negative voltage generator may be output via an electrode of which potential level is same as potential level of a substrate, or the like. At least some of the transistors of the negative voltage generator may have a body connected to the substrate, and these transistors should withstand high potential differences between the gate and the body. As these transistors may be large in size and have lower operating performance than that of other transistors, there is a need for an apparatus and a method for increasing the operating performance of a negative voltage generator.

### SUMMARY

One or more example embodiments provide the negative voltage generator, the operation method thereof, and the electronic device including the same, which reduce the number of transistors having a high potential difference between a gate and a body among a plurality of transistors in the negative voltage generator, and have smaller size and improved operation performance.

According to an aspect of an example embodiment, a voltage generator including: a first stage circuit configured to receive a first input voltage via a first input node, and output, based on the first input voltage, a first output voltage via a first output node; and a second stage circuit configured to receive the first input voltage via a second input node, receive a second input voltage via a third input node, and output, based on the first and second input voltages, a second output voltage via a second output node. The second stage circuit includes: a first start-up switch configured to connect the second input node and a first node; a second start-up switch configured to connect a ground node and a second node; a first switch configured to connect the third input node and the first node; a second switch configured to connect the first node and the ground node; a third switch configured to connect the second node and the first output node; a fourth switch configured to connect the second node and the second output node; and a first capacitor connected between the first node and the second node.

According to another aspect of an example embodiment, a method of operating a voltage generator including a first output node and a second output node, the method including: generating, based on a first input voltage, a first output voltage at the first output node and the second output node; charging a first capacitor with electric charges corresponding to the first input voltage, and charging a second capacitor with electric charges corresponding to a sum of the first input voltage and a second input voltage; and generating the first output voltage at the first output node and generating a second output voltage at the second output node. The first output voltage is equal in magnitude to the first input voltage, and opposite in sign to the first input voltage.

According to another aspect of an example embodiment, a display driver integrated circuit (IC) (DDI) includes: a start-up stage circuit configured to generate, based on a first input voltage, a negative first input voltage; a first stage circuit configured to generate, based on the first input voltage and the negative first input voltage, a first output voltage; and a second stage circuit configured to generate a second output voltage based on a second input voltage and the negative first input voltage.

According to another aspect of an example embodiment, a voltage generator configured to operate in a start-up mode and a normal mode is provided. The voltage generator includes: a first stage circuit configured to generate a first output voltage at a first output node, based on a first input voltage; and a second stage circuit configured to generate a second output voltage at a second output node, based on a second input voltage. The second stage circuit generates the first output voltage at the first output node and the second output node in the start-up mode. The first output voltage is equal in level and opposite in sign to the first input voltage. The second output voltage is equal to and opposite in sign to a sum of the first input voltage and the second input voltage. The voltage generator generates the first output voltage on the first output node, and the second output voltage on the second output node in the normal mode.

According to another aspect of an example embodiment, a voltage generator is provided. The voltage generator includes: a first stage circuit configured to receive a first input voltage via a first input node and output a first output voltage at a first output node based on the first input voltage; and a second stage circuit configured to receive the second input voltage via a second input node and output a second output voltage at a second output node based on the second input voltage. The second stage circuit includes: a first switch configured to connect the second input node and a first node; a second switch configured to connect the first node and a ground node; a third switch configured to connect a second node and the first output node; a fourth switch configured to connect the second node and the second output node; a start-up switch configured to connect the ground node and the second node; and a first capacitor connected between the first node and second node.

In an embodiment, a level of the first input voltage and a level of the second input voltage are the same.

### BRIEF DESCRIPTION OF DRAWINGS

The above and other aspects will be more apparent from the following description of example embodiments, taken in conjunction with the accompanying drawings, in which:

FIG. 1 is a block diagram of a display apparatus, in accordance with an example embodiment;

FIG. 2 is a circuit diagram of a negative voltage generator in detail, in accordance with an example embodiment;

FIG. 3 is a timing diagram of an example of operation of the negative voltage generator of FIG. 2, in accordance with an example embodiment;

FIG. 4 is a circuit diagram of a negative voltage generator in detail, in accordance with an example embodiment;

FIG. 5 is a flowchart of an example of an operation method of the negative voltage generator of FIG. 4, in accordance with an example embodiment;

FIG. 6 is a flowchart of an example of an operation method of the negative voltage generator in a start-up mode, in accordance with an example embodiment;

FIG. 7 is a graph of the level change of the output voltages for each operating mode of the negative voltage generator of FIG. 4, in accordance with an example embodiment;

FIG. 8 is a graph of changes in signal and voltage levels according to the operation of the negative voltage generator of FIG. 4, in accordance with an example embodiment;

FIGS. 9A, 9B, 9C and 9D are circuit diagrams of an example of states of switches respectively, in each of the operations of FIG. 8, in accordance with an example embodiment;

FIG. 10 is a circuit diagram of a negative voltage generator in detail, in accordance with an example embodiment;

FIG. 11 is a circuit diagram of an example of a detailed implementation of the negative voltage generator of FIG. 2, in accordance with an example embodiment;

FIG. 12 is a circuit diagram of an example of a detailed implementation of the negative voltage generator of FIG. 4, in accordance with an example embodiment;

FIG. 13 is a circuit diagram of a negative voltage generator in detail, in accordance with an example embodiment; and

FIG. 14 is a block diagram of an electronic device, in accordance with an example embodiment.

### DETAILED DESCRIPTION

Hereinafter, embodiments are described in detail with reference to the accompanying drawings. As used herein, the terms “1st” or “first” and “2nd” or “second” may use corresponding components regardless of importance or order and are used to distinguish a component from another component without limiting the components.

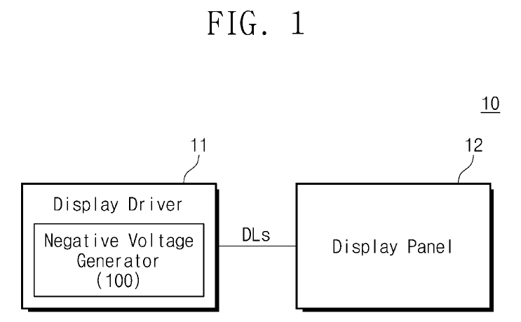

FIG. 1 is a block diagram of a display apparatus, in accordance with an example embodiment. Referring to FIG. 1, a display device 10 may include a display driver 11 and a display panel 12.

The display driver 11 may control the operation of the display device 10. For example, the display driver 11 may control the display panel 12 such that the display device 10 displays an image or images. In an example embodiment, the display driver 11 may provide power or voltage required for operation of the display panel 12 to the display panel 12.

The display driver 11 may control the operation of the display panel 12 based on the image information. In an example embodiment, the display driver 11 may control the operation of the display panel 12 based on one or more signals. For example, the display driver 11 may control the operation of the display panel 12 by controlling one or more signals to be provided to the display panel 12 via data lines DLs. For example, the data lines DLs may include source driver lines.

In an example embodiment, the display driver 11 may further include a gate driver to control the gate lines of the display panel 12. In an example embodiment, the display panel 12 may include a gate line driver that controls the gate lines. In this case, the gate line driver may select a gate line to be turned on in response to a control signal (e.g., an Hsync signal) received from the display driver 11.

In an example embodiment, the display driver 11 may be implemented as a display driving integrated circuit (DDI). In an example embodiment, the display driver 11 may include one or more voltage generators (e.g., voltage generation circuits). For example, as shown in FIG. 1, the display driver 11 may include a negative voltage generator (e.g., negative voltage generation circuit) 100. The negative voltage generator 100 may generate one or more voltages having a negative voltage level used or required for operation of the display device 10. In an example embodiment, the display driver 11 may provide the negative voltages generated by the negative voltage generator 100 to the display panel 12.

In an example embodiment, the negative voltage generator 100 may include a charge pump (e.g., charge pump circuit) and a controller (e.g., control circuit). For example, the negative voltage generator 100 may include a charge pump that generates a first output voltage and a second output voltage and a controller that generates one or more control signals that control the charge pump and delivers to the charge pump. The configuration and operation of the charge pump is described in more detail with reference to the following drawings.

The display panel 12 may visually display image data, an image data signal, image data, or the like. In some example embodiments, the display panel 12 may be or include one of various display panels or combination of the various display panel. For example, the display panel 12 may be or include one of a liquid crystal display (LCD) panel, an organic light emitting diode (OLED) panel, a microLED panel, or the like, or combination thereof. In some example embodiments, display panel 12 may be or include a panel that receives touch input. For example, the display panel 12 may include one or more touch sensors, and may further include a processor or a processing circuit to process a signal generated according to an input received by the touch sensor.

The configuration of the display driver 11 or the display panel 12 is illustrative and example embodiments are not limited thereto. It should be understood that according to some example embodiments, the display driver 11 further includes a processor for controlling the display device 10, a buffer memory for storing data (e.g., temporarily), an interface circuit for communicating with the display panel 12, and/or the like. According to an example embodiment, the display panel 12 further includes processing circuit processing one or more signals received via the data lines DLs in addition to the various panels.

According to an example embodiment, the display device 10 further includes a wired or wireless communication device, an interface circuit, a buffer memory, or the like in addition to the display driver 11 and the display panel 12. With reference to the following figures, a negative voltage generator that is miniaturized and has improved resistance characteristics is described.

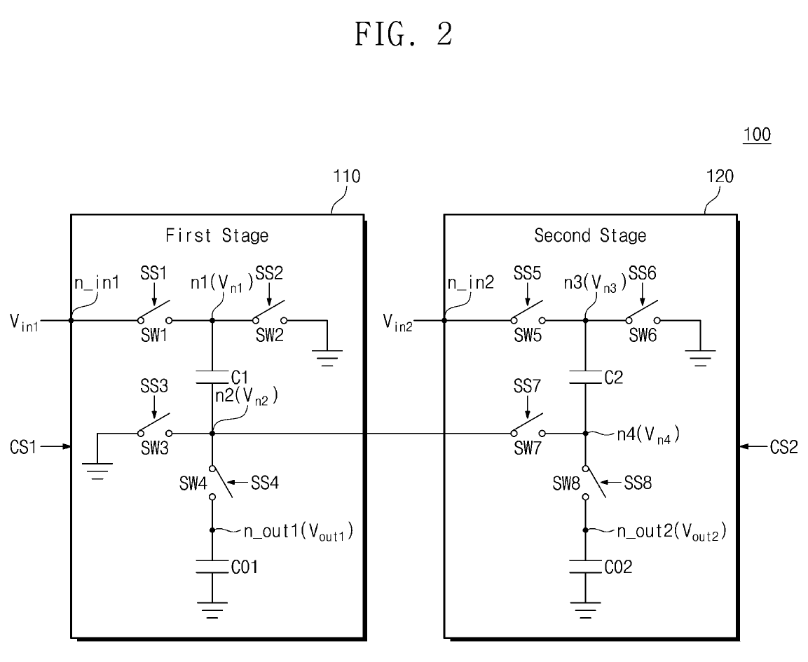

FIG. 2 is a circuit diagram of a negative voltage generator in detail, in accordance with an example embodiment. Referring to FIG. 2, a negative voltage generator 100 may include a first stage (e.g., first stage circuit) 110 and a second stage (e.g., second stage circuit) 120. The first stage 110 and the second stage 120 may constitute a charge pump of the negative voltage generator 100. The first stage 110 and the second stage 120 may be a division according to a convenience of description, a function, or a role, and may not correspond to a division on physical or hardware.

Referring to FIG. 2, the first stage 110 may include first to fourth switches (e.g., switch circuits) SW1-SW4, a first capacitor C1, and a first output capacitor CO1. The first switch SW1 may be connected between a first input node n_in1 and a first node n1, and may operate in response to a first switch signal SS1. The first input voltage Vᵢₙ₁ may be applied via the first input node n_in1. The second switch SW2 may be connected between the first node n1 and a ground node, and may operate in response to a second switch signal SS2. The voltage of the first node n1 may be the first node voltage Vₙ₁.

The third switch SW3 may be connected between a second node n2 and the ground node, and may operate in response to a third switch signal SS3. The fourth switch SW4 may be connected between the second node n2 and a first output node n_out1, and may operate in response to a fourth switch signal SS4. The voltage of the second node n2 may be the second node voltage Vₙ₂. The first capacitor C1 may be connected between the first node n1 and the second node n2. The first output capacitor CO1 may be connected between the first output node n_out1 and the ground node.

Referring to FIG. 2, the second stage 120 may include fifth to eighth switches SW5-SW8, a second capacitor C2, and a second output capacitor CO2. The fifth switch SW5 may be connected between a second input node n_in2 and a third node n3, and may operate in response to the fifth switch signal SS5. The second input voltage Vᵢₙ₂ may be applied via the second input node n_in2. The sixth switch SW6 may be connected between the third node n3 and the ground node, and may operate in response to the sixth switch signal SS6. The voltage of the third node n3 may be the third node voltage Vₙ₃.

The seventh switch SW7 may be connected between the second node n2 and a fourth node n4, and may operate in response to the seventh switch signal SS7. The eighth switch SW8 may be connected between the fourth node n4 and the second output node n_out2 and may operate in response to an eighth switch signal SS8. The voltage of the fourth node n4 may be the fourth node voltage Vₙ₄. The second capacitor C2 may be connected between the third node n3 and the fourth node n4. The second output capacitor CO2 may be connected between the second output node n_out2 and the ground node.

The first stage 110 may generate the first output voltage Vₒᵤₜ₁ based on the first input voltage Vᵢₙ₁ in response to a first control signal CS1. The first control signal CS1 may be a signal generated by a controller (e.g., a controller that controls a charge pump) of the negative voltage generator 100. In an example embodiment, the first output voltage Vₒᵤₜ₁ may be or correspond to a negative first input voltage −Vᵢₙ₁. That is, the level of the first output voltage Vₒᵤₜ₁ may be equal in magnitude to the level of the first input voltage Vᵢₙ₁, and may be opposite in sign.

The second stage 120 may generate the second output voltage Vₒᵤₜ₂ based on the second input voltage Vᵢₙ₂ in response to a second control signal CS2. The second control signal CS2 may be a signal generated by a controller (e.g., a controller that controls a charge pump) of the negative voltage generator 100. In an example embodiment, the second output voltage Vₒᵤₜ₂ may be or correspond to a sum of the negative first input voltage −Vᵢₙ₁ and the negative second input voltage − Vᵢₙ₂, i.e., −(Vᵢₙ₁+Vᵢₙ₂). That is, the level of the second output voltage Vₒᵤₜ₂ may be equal in magnitude to the level of the sum of the first input voltage Vᵢₙ₁ and the second input voltage Vᵢₙ₂, and may be opposite in sign.

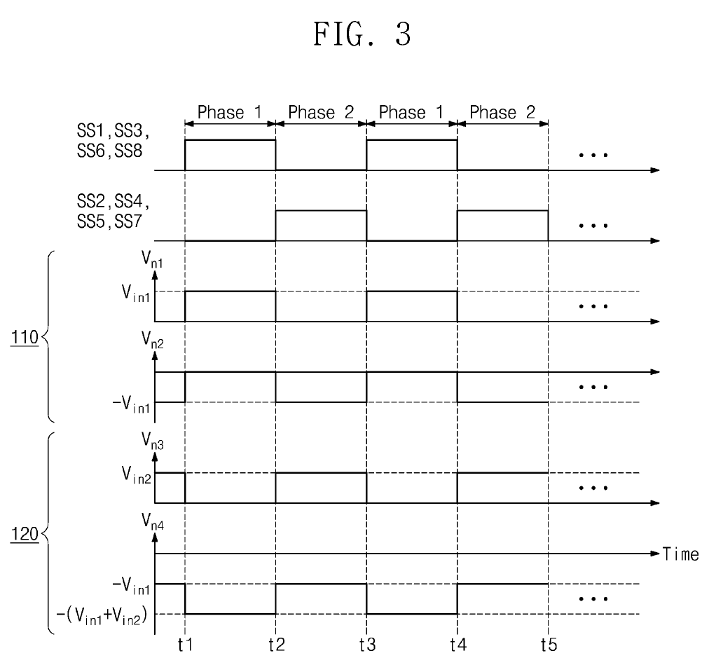

Although the first stage 110 is shown and described in FIG. 2 as including the first output node n_out1 and the first output capacitor CO1, this is illustrative and according to an example embodiment the first output node n_out1 or first output capacitor CO1 is located outside the first stage 110. Similarly, although the second stage 120 is shown and described in FIG. 2 as including the second output node n_out2 and the second output capacitor CO2, this is illustrative and according to an example embodiment the second output node n_out2 or second output capacitor CO2 is located outside the second stage 120. The negative voltage generation operation of the negative voltage generator 100 is described in more detail with reference to FIG. 3.

FIG. 3 is a timing diagram of an example of operation of the negative voltage generator of FIG. 2, in accordance with an example embodiment. Referring to FIGS. 2 and 3, each of the switches is described with reference to being turned on in response to the corresponding switch signal being at a logical high level. It should be understood, however, that this is illustrative and that according to some example embodiments, all or some of the switches may operate in response to a corresponding switch signal being at a logical low level. With reference to FIGS. 2 and 3, an operation of a negative voltage generator in accordance with an example embodiment will be specifically described.

A first operation may be performed from the first time point t1 to the second time point t2 (e.g., phase 1, or a first operation period). In the first operation, the first switch signal SS1, the third switch signal SS3, the sixth switch signal SS6, and the eighth switch signal SS8 may be at the logical high level. In the first operation, the second switch signal SS2, the fourth switch signal SS4, the sixth switch signal SS6, and the eighth switch signal SS8 may be at the logical low level.

In the first operation, the first node n1 may be connected to the first input node n_in1 via the first switch SW1. In this case, the first node voltage Vₙ₁ may be the first input voltage Vᵢₙ₁. The second node n2 may be connected to the ground node via the third switch SW3. In the first operation, the first capacitor C1 may accumulate electric charges corresponding to the first input voltage Vᵢₙ₁, which is a potential difference between the first node n1 and the second node n2.

In the first operation, the third node n3 may be connected to the ground node via a sixth switch SW6, and the fourth node n4 may be connected to the second output node n_out2 via an eighth switch SW8. The level of the fourth node voltage Vₙ₄ may be equal to the sum of the levels of the first input voltage Vᵢₙ₁and the second input voltage Vᵢₙ₂ and opposite in sign in the first operation. That is, the fourth node voltage Vₙ₄ may be equal to − (Vᵢₙ₁+Vᵢₙ₂) in the first operation. In the first operation, as the fourth node n4 and the second output node n_out2 are connected, the level of the second output voltage Vₒᵤₜ₂ may be the same as the level of the fourth node voltage Vₙ₄. In the first operation, the negative voltage generator 100 may output the second output voltage Vₒᵤₜ₂ at the second output node n_out2.

A second operation may be performed from the second time point t2 to a third time point t3 (e.g., phase 2, or a second operation period). In the second operation, the first switch signal SS1, the third switch signal SS3, the sixth switch signal SS6, and the eighth switch signal SS8 may be at the logical low level. In the second operation, the second switch signal SS2, the fourth switch signal SS4, the sixth switch signal SS6, and the eighth switch signal SS8 may be at the logical high level.

In the second operation, the first node n1 may be connected to the ground node via the second switch SW2. In this case, the first node voltage Vₙ₁ may be a ground voltage. The second node n2 may be connected to the first output node n_out1 via the fourth switch SW4. The second node voltage Vₙ₂may be a negative first input voltage −Vᵢₙ₁ in the second operation. This is because the first node n1, which is a high-potential stage of the first capacitor C1, is connected to the ground node. That is, the level of the second node voltage Vₙ₂ may be or correspond to a level of the negative first input voltage −Vᵢₙ₁ in the second operation.

In the second operation, the third node n3 may be connected to the second input node n_in2 through the fifth switch SW5. In this case, the third node voltage Vn3 may be the second input voltage Vᵢₙ₂. The fourth node n4 may be connected to the second node n2 via a seventh switch SW7. In the second operation, the level of the fourth node voltage Vₙ₄ may be a level of the negative first input voltage −Vᵢₙ₁ which is a level of the second node voltage Vₙ₂ in the second operation.

In the second operation, the second capacitor C2 may accumulate electric charges corresponding to a sum of the first input voltage Vᵢₙ₁ and the second input voltage Vᵢₙ₂, which is a potential difference between the third node n3 and the fourth node n4. That is, in the second operation, the second capacitor C2 may accumulate electric charges corresponding to (Vᵢₙ₁+Vᵢₙ₂). In the second operation, as the second node n2 and the first output node n_out1 are connected, the level of the second node voltage Vₙ₂ and the level of the first output voltage Vₒᵤₜ₁ may be the same. In the second operation, the negative voltage generator 100 may output the first output voltage Vₒᵤₜ₁ at the first output node n_out1.

The first operation may be performed again from the third time point t3 to the fourth time point t4, and the negative voltage generator 100 may operate the same as or similar to the operation(s) of the first time point t1 to the second time point t2. As the second capacitor C2 accumulate electric charges corresponding to the sum of the first input voltage Vᵢₙ₁ and the second input voltage Vᵢₙ₂ in the second operation and the third node n3 is connected to the ground node in the first operation, the fourth node voltage Vₙ₄ may be the sum of or correspond to the first input voltage −Vᵢₙ₁ and the negative second input voltage −Vᵢₙ₂ in the first operation. The second operation may be performed again from the fourth time point t4 to the fifth time point t5, and the negative voltage generator 100 may operate the same as or similar to the operation(s) of the second time point t2 to the third time point t3. After the fifth time point t5, the negative voltage generator 100 may repeatedly perform the first operation and the second operation to generate the first output voltage Vₒᵤₜ₁ and the second output voltage Vₒᵤₜ₂.

In an example embodiment, the negative voltage generator 100 may repeat the operation(s) of the first operation or the second operation at least once before the first time point t1. For example, the negative voltage generator 100 may charge (e.g., in advance) the capacitors C1, C2 as much charge as necessary for the operation of FIG. 3, based on repeating one or more operation(s) of the first operation or the second operation prior to the first time point t1. The operation of the negative voltage generator 100 described with reference to FIG. 3 is illustrative and should not be construed to limit example embodiments to the graphs shown in FIG. 3, and it should be understood that at least some of the graphs of FIG. 3 may be shown with some exaggeration for ease of description.

In an example embodiment, the negative voltage generator 100 may perform the operation(s) for a predetermined amount of time and then change the operation (e.g., next operation). For example, the negative voltage generator 200 may perform the operation(s) of the first operation for a predetermined amount of time and then change to the second operation. In an example embodiment, the negative voltage generator 100 may perform a operation change operation by a controller.

It should also be understood that according to some example embodiments the change in each of the switch signals, the form of the change in the voltage level, or the waveform of FIG. 3 changes differently than shown in FIG. 3 (e.g., example embodiments in which the voltage level or signal level increases or decreases more slowly than the form of the changes in the voltage level(s) or signal level(s) of FIG. 3). In FIG. 3, the time points t1-t5 are intended to indicate the order of the operations, and it should be understood that the interval between the time points t1-t5 does not necessarily correspond to the actual time at which the operation is performed.

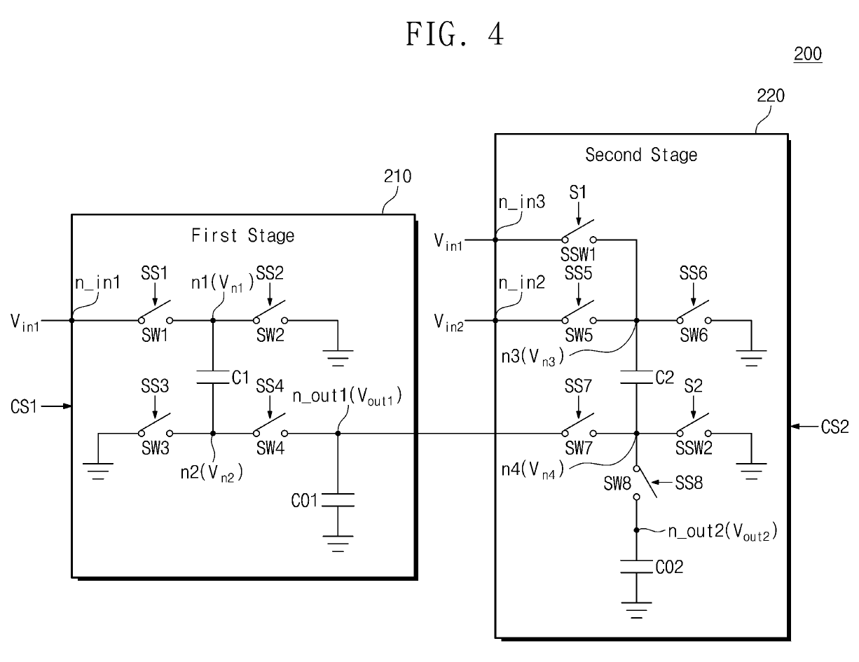

FIG. 4 is a circuit diagram of a negative voltage generator in detail, in accordance with an example embodiment. Referring to FIG. 4, the negative voltage generator 200 may include a first stage 210 and a second stage 220. The first stage 210 and the second stage 220 may constitute a charge pump of the negative voltage generator 200. The first stage 210 and the second stage 220 may be a division for convenience of description or on function, or a role, or may not correspond to a division on physical or hardware.

Referring to FIG. 4, the first stage 210 may include first to fourth switches SW1-SW4, a first capacitor C1, and a first output capacitor CO1. The first switch SW1 may be connected between a first input node n_in1 and a first node n1, and may operate in response to a first switch signal SS1. The first input voltage Vᵢₙ₁ may be applied via the first input node n_in1. The second switch SW2 may be connected between the first node n1 and a ground node, and may operate in response to a second switch signal SS2. The voltage of the first node n1 may be the first node voltage Vₙ₁.

The third switch SW3 may be connected between a second node n2 and the ground node, and may operate in response to a third switch signal SS3. The fourth switch SW4 may be connected between the second node n2 and the first output node n_out1, and may operate in response to a fourth switch signal SS4. The voltage of the second node n2 may be the second node voltage Vₙ₂. The first capacitor C1 may be connected between the first node n1 and the second node n2. The first output capacitor CO1 may be connected between the first output node n_out1 and the ground node.

Referring to FIG. 4, the second stage 220 may include start-up switches SSW1, and SSW2, fifth to eighth switches SW5-SW8, a second capacitor C2, and a second output capacitor CO2. The fifth switch SW5 may be connected between a second input node n_in2 and a third node n3, and may operate in response to a fifth switch signal SS5. The second input voltage Vᵢₙ₂ may be applied via the second input node n_in2. The sixth switch SW6 may be connected between the third node n3 and the ground node, and may operate in response to a sixth switch signal SS6. The voltage of the third node n3 may be the third node voltage Vₙ₃.

The seventh switch SW7 may be connected between the first output node n_out1 and a fourth node n4, and may operate in response to a seventh switch signal SS7. The eighth switch SW8 may be connected between the fourth node n4 and a second output node n_out2 and may operate in response to an eighth switch signal SS8. The voltage of the fourth node n4 may be the fourth node voltage Vₙ₄. The second capacitor C2 may be connected between the third node n3 and the fourth node n4. The second output capacitor CO2 may be connected between the second output node n_out2 and the ground node.

The first start-up switch SSW1 may be connected between a third input node n_in3 and the third node n3, and may operate in response to a first start-up switch signal S1. The first input voltage Vᵢₙ₁ may be applied via the third input node n_in3, (to the second stage 220). The second start-up switch SSW2 may be connected between the fourth node n4 and the ground node, and may operate in response to a second start-up switch signal S2.

The first stage 210 may generate the first output voltage Vₒᵤₜ₁ based on the first input voltage Vᵢₙ₁ in response to the first control signal CS1. The first control signal CS1 may be a signal generated by a controller (e.g., a controller that controls the charge pump) of the negative voltage generator 200. In an example embodiment, the first output voltage Vₒᵤₜ₁ may be a negative first input voltage −Vᵢₙ₁ or may correspond to the negative first input voltage −Vᵢₙ₁. That is, the level of the first output voltage Vₒᵤₜ₁ may be equal in magnitude to the level of the first input voltage Vᵢₙ₁, and may be opposite in sign.

The second stage 220 may generate the second output voltage Vₒᵤₜ₂ based on the second input voltage Vᵢₙ₂ in response to the second control signal CS2. The second control signal CS2 may be a signal generated by a controller (e.g., a controller that controls the charge pump) of the negative voltage generator 100. In an example embodiment, the second output voltage Vₒᵤₜ₂ may be or correspond to a sum of the negative first input voltage −Vᵢₙ₁ and the negative second input voltage − Vᵢₙ₂ i.e., −(Vᵢₙ₁+Vᵢₙ₂). That is, the level of the second output voltage Vₒᵤₜ₂ may be equal in magnitude to the level of the sum of the first input voltage Vᵢₙ₁ and the second input voltage Vᵢₙ₂, and may be opposite in sign.

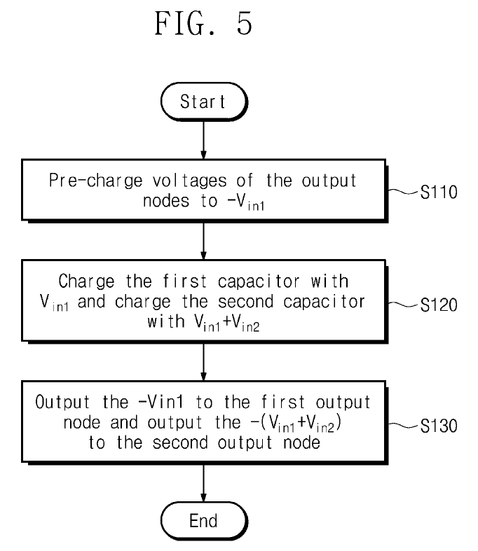

Although the first stage 210 is shown and described in FIG. 4 as including the first output node n_out1 and the first output capacitor CO1, this is illustrative and it should be understood that in some example embodiments, the first output node N_out1 or first output capacitor CO1 may be located outside the first stage 210. Similarly, although the second stage 220 is shown and described in FIG. 2 as including the second output node n_out2 and the second output capacitor CO2, this is illustrative and it should be understood that according to some example embodiments the second output node N_out2 or second output capacitor CO2 may be located outside the second stage 220. The negative voltage generation operation of the negative voltage generator 200 is described in more detail with reference to FIGS. 5-8, 9A, 9B, 9C, 9D.

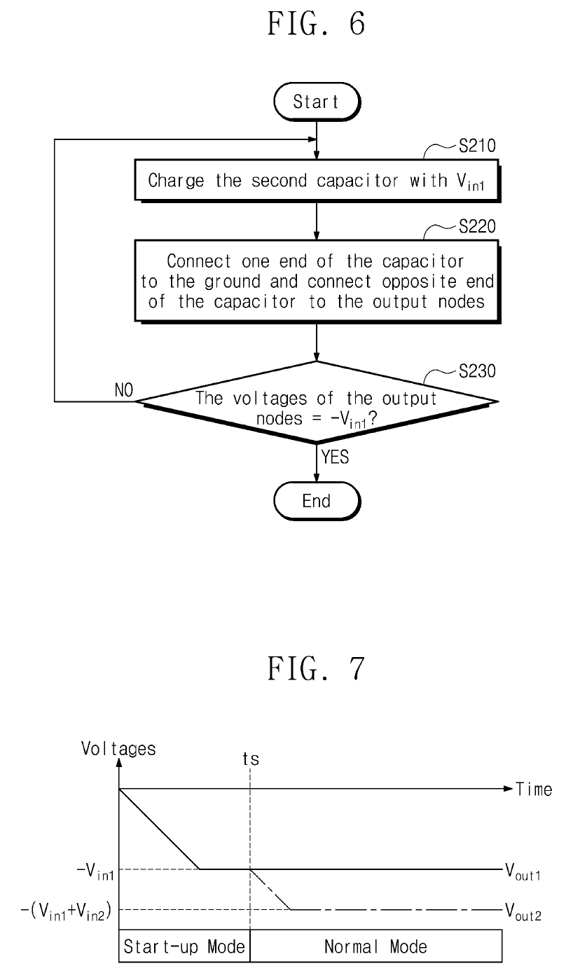

FIG. 5 is a flowchart of an example of a method of operating the negative voltage generator of FIG. 4, in accordance with an example embodiment. In operation S110, the negative voltage generator 200 may apply a negative first input voltage −Vᵢₙ₁ on the output nodes n_out1 and n_out2. In an example embodiment, the negative voltage generator 200 may apply a negative first input voltage −Vᵢₙ₁ to the output nodes n_out1 and n_out2 via the start-up switches SSW1 and SSW2. The operation S110 is described in more detail with reference to FIGS. 6-8.

In operation S120, the negative voltage generator 200 may charge the first capacitor C1 with electric charges corresponding to the first input voltage Vᵢₙ₁. For example, based on connecting the second node n2 to the ground node and applying the first input voltage Vᵢₙ₁ on the first node n1, the negative voltage generator 200 may charge the first capacitor C1 with electric charges corresponding to the first input voltage Vᵢₙ₁. The negative voltage generator 200 may charge the second capacitor C2 with electric charges corresponding to the sum of the first input voltage Vᵢₙ₁ and the second input voltage Vᵢₙ₂. For example, based on applying the second input voltage Vᵢₙ₂to the third node n3 and connecting the fourth node n4 to the first output node n_out1, the negative voltage generator 200 may charge the second capacitor C2 with electric charges corresponding to a sum of the first input voltage Vᵢₙ₁and the second input voltage Vᵢₙ₂.

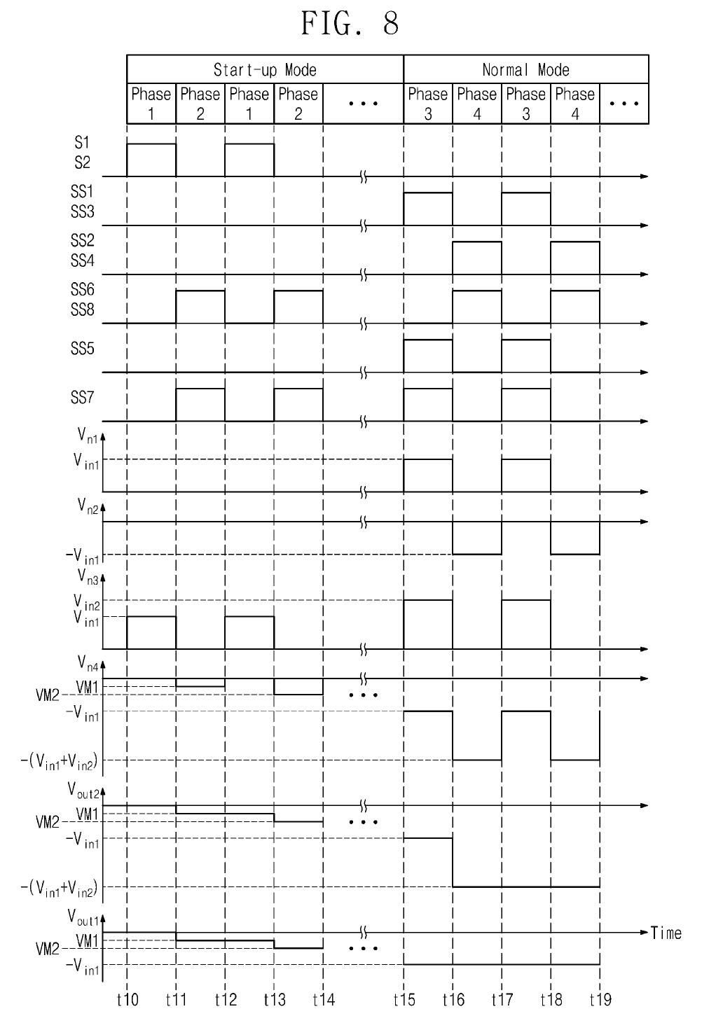

In operation S130, the negative voltage generator 200 may output the first output voltage Vₒᵤₜ₁ and the second output voltage Vₒᵤₜ₂. In an example embodiment, the negative voltage generator 200 may output the first output voltage Vₒᵤₜ₁ at the first output node n_out1, and may output the second output voltage Vₒᵤₜ₂ at the second output node n_out2. For example, the negative voltage generator 200 may output the negative first input voltage −Vᵢₙ₁ at the first output node n_out1. For example, the negative voltage generator 200 may output a sum of the negative first input voltage -Vᵢₙ₁ and the negative second input voltage -Vᵢₙ₂, i.e., −(Vᵢₙ₁+Vᵢₙ₂) on the second output node n_out2. Operation S130 is described in more detail with reference to FIG. 8.

The operations described with reference to FIG. 5 are illustrative and it should be understood that the negative voltage generator 200 does not necessarily perform the operations described with reference to FIG. 5 sequentially. It is to be understood that example embodiments in which at least some of the operations of FIG. 5 overlap or in which some or all of the operations are performed simultaneously are also within the scope of the present invention. For example, the negative voltage generator 200 may simultaneously perform at least a part of each of the operations S120 and S130, or may perform at least some of the operations in an overlapping manner.

FIG. 6 is a flowchart of an example of a method of a negative voltage generator operating in a start-up mode, in accordance with an example embodiment. A method of operating the negative voltage generator 200 in a start-up mode in accordance with an example embodiment is described with reference to FIGS. 4-6.

In operation S210, the negative voltage generator 200 may charge the second capacitor C2 to the first input voltage Vᵢₙ₁. For example, the second capacitor C2 may accumulate electric charges corresponding to the first input voltage Vᵢₙ₁. In an example embodiment, the negative voltage generator 200 may charge the second capacitor C2 via the start-up switches SSW1 and SSW2. For example, the negative voltage generator 200 may charge the second capacitor C2 by applying the first input voltage Vᵢₙ₁ to one end (for example, the third node n3 in FIG. 4) of the second capacitor C2, and applying a ground voltage to the other end (for example the fourth node n4 in FIG. 4), based on turning on all of the start-up switches SSW1 and SSW2.

In operation S220, the negative voltage generator 200 may connect one end of the second capacitor C2 to the ground node and connect the other end to the output nodes n_out1 and n_out2. The negative voltage generator 200 may apply a negative voltage to the output nodes n_out1 and n_out2 based on connecting the high-potential end of the capacitor C2 to the ground node and connecting the opposite end to the output nodes n_out1 and n_out2. For example, the negative voltage generator 200 may perform the operation in operation S220 based on connecting the third node n3 to the ground node and connecting the fourth node n4 with the output nodes n_out1 and n_out2.

In operation S230, the negative voltage generator 200 may determine a next operation to proceed, based on whether the output voltages Vₒᵤₜ₁, Vₒᵤₜ₂ reach the negative first input voltage −Vᵢₙ₁. When it is determined the output voltages Vₒᵤₜ₁, Vₒᵤₜ₂ have not reached the negative first input voltage −Vᵢₙ₁, the negative voltage generator 200 may return to operation S210. Conversely, when it is determined the output voltages Vₒᵤₜ₁, Vₒᵤₜ₂ have reached the negative first input voltage −Vᵢₙ₁, the negative voltage generator 200 may end the operation(s) of the start-up mode.

While FIG. 6 describes an example in which the operation is immediately terminated, when it is determined the output voltages Vₒᵤₜ₁, Vₒᵤₜ₂ of the negative voltage generator 200 have reached the negative first input voltage −Vin1, this is illustrative, and it should be understood that according to an example embodiment, the operation of operation S210 and operation S220 may be repeated one or more times after the time when the output voltages reach the negative first input voltage -Vᵢₙ₁, and the operation may then be terminated. In an example embodiment, the operations of FIG. 6 may correspond to the operations of operation S110 of FIG. 5. After completing the operation of FIG. 6, the negative voltage generator 200 may proceed to operation S120 of FIG. 5 or perform normal mode operations. The normal mode of the negative voltage generator 200 is described in more detail with reference to FIG. 8.

FIG. 7 is a graph of a level change of output voltages for each operating mode of the negative voltage generator of FIG. 4, in accordance with an example embodiment. Referring to FIG. 7, a change over time for each mode of levels of each of the first output voltage Vₒᵤₜ₁ and the second output voltage Vₒᵤₜ₂ is illustrated. In FIG. 7, the level change of the first output voltage Vₒᵤₜ₁ is shown as a straight line, and the level change of a second output voltage Vₒᵤₜ₂ is shown as a dashed-dotted line. Through FIGS. 4 to 7, a change in the output voltages Vₒᵤₜ₁, Vₒᵤₜ₂ according to the operation modes of the negative voltage generator 200 is described.

In some example embodiments, the negative voltage generator 200 may have a plurality of operating modes. For example, the negative voltage generator 200 may have a start-up mode and a normal mode. In an example embodiment, the negative voltage generator 200 may generate the output voltages Vₒᵤₜ₁having its target level and Vₒᵤₜ₂ having its target level, based on sequentially passing through the modes. For example, the negative voltage generator 200 may perform start-up mode operations until a switch time point ts, and may perform normal mode operations after the switch time.

The negative voltage generator 200 may contorl the first output voltage Vₒᵤₜ₁ and the second output voltage Vₒᵤₜ₂ to have a level of the negative first input voltage −Vᵢₙ₁ in the start-up mode. In one example embodiment, the first output voltage Vₒᵤₜ₁ and the second output voltage Vₒᵤₜ₂ may be equally changed in level in the start-up mode to reach the negative first input voltage −Vᵢₙ₁. The change in the output voltages Vₒᵤₜ₁, Vₒᵤₜ₂ in the start-up mode shown in FIG. 7 may be a schematic illustration or an illustration to show a tendency of the change, and it should be understood that the levels of each of the output voltages Vₒᵤₜ₁, Vₒᵤₜ₂ do not necessarily change linearly as shown in FIG. 7. In FIG. 7, the output voltages Vₒᵤₜ₁, Vₒᵤₜ₂ are shown to change to the same level across all time points within the start-up mode, but this is illustrative, and it should be understood that an example embodiment in which the level of each of the output voltages Vₒᵤₜ₁, Vₒᵤₜ₂ is different from each other at least some of the time points within the start-up mode is also within the scope of the present invention. The operation of the switches in the start-up mode of the negative voltage generator is described in more detail, via FIG. 8.

The negative voltage generator 200 may perform normal mode operations after the switch time point ts. In an example embodiment, the levels of each of the first output voltage Vₒᵤₜ₁ and the second output voltage Vₒᵤₜ₂ may be different in the normal mode. For example, the first output voltage Vₒᵤₜ₁ may maintain a negative first input voltage −Vᵢₙ₁ in the normal mode, while the second output voltage Vₒᵤₜ₂ may change to a sum of the negative first input voltage −Vᵢₙ₁ and the negative second input voltage −Vᵢₙ₂. That is, the level of the second output voltage Vₒᵤₜ₂ may be equal to the level of –(Vᵢₙ₁+Vᵢₙ₂).

The change in the output voltages Vₒᵤₜ₁, Vₒᵤₜ₂ in the normal mode shown in FIG. 7 may be a schematic illustration or illustration to show a tendency, and it should be understood that the output voltages Vₒᵤₜ₁, Vₒᵤₜ₂ do not necessarily change linearly as shown in FIG. 7. For example, the level of the second output voltage Vₒᵤₜ₂ may change non-linearly (e.g., in the form of a step, etc.), unlike that shown in FIG. 7 in the normal mode. The operation of the switches in the normal mode of the negative voltage generator is described in more detail, via FIG. 8.

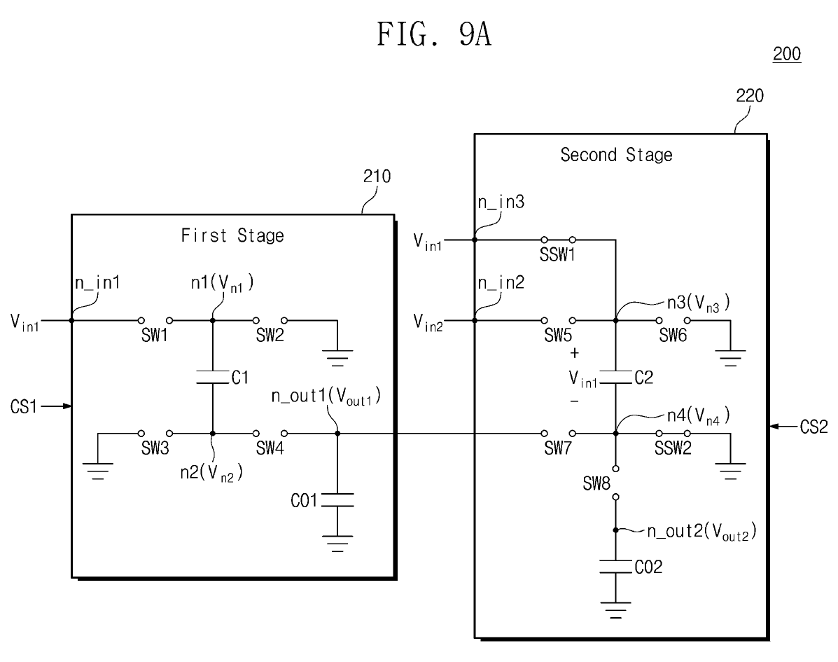

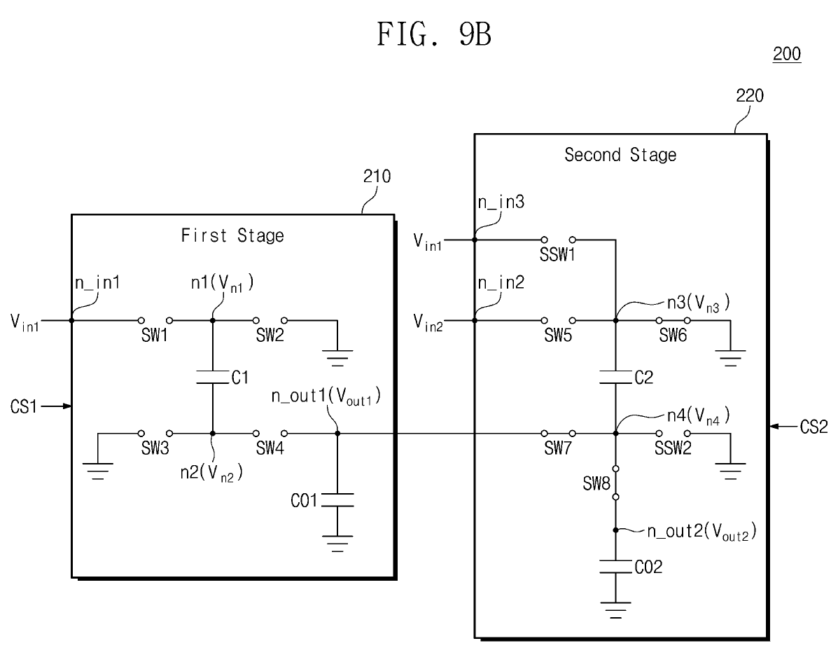

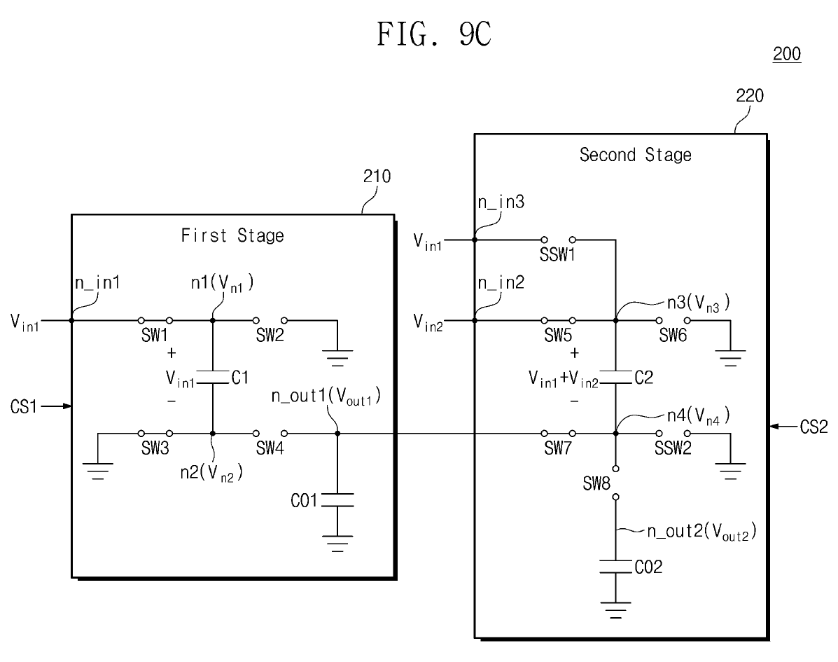

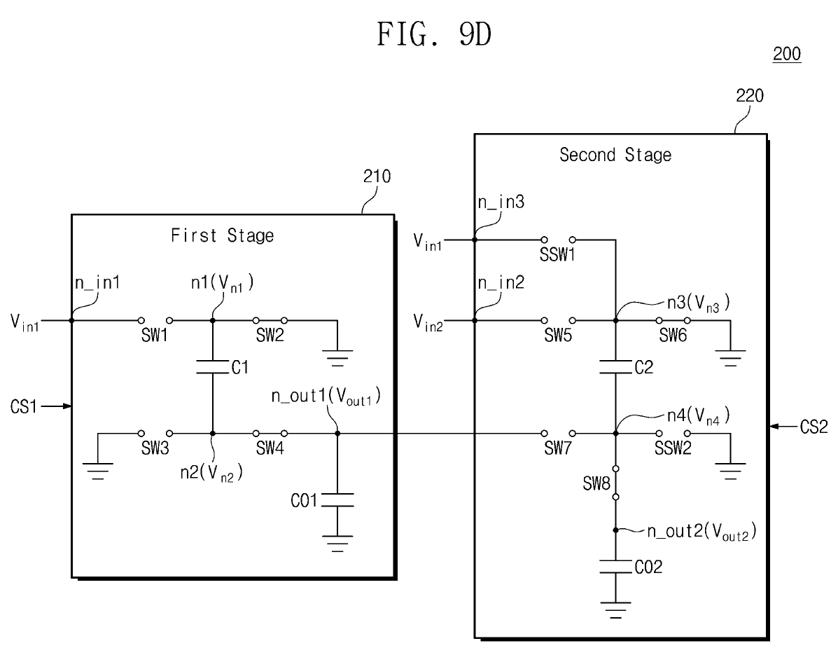

FIG. 8 is a graph of changes in signals and voltage levels with operation of the negative voltage generator of FIG. 4, in accordance with an example embodiment. FIGS. 9A-9D are circuit diagrams of an example of states of switches respectively, in each of the operations of FIG. 8, in accordance with an example embodiment. In FIG. 8, each of the switches is described with reference to being turned on in response to the corresponding switch signal being at the logical high level. It should be understood, however, that this is illustrative and according to some example embodiments, all or some of the switches may operate in response to a corresponding switch signal being at the logical low level. In FIG. 8, the levels of each of the intermediate voltages VM1 and VM2 may be a value between the ground voltage level and the level of the negative first input voltage −Vᵢₙ₁. Through FIGS. 8 and 9A-9D, the operation of the negative voltage generator 200 is described in detail.

Referring to FIG. 8, the negative voltage generator 100 may operate in a start-up mode from a tenth time point t10 to a fifteenth time point t15, and may operate in a normal mode after the fifteenth time point t15. In an example embodiment, the negative voltage generator 200 may change the mode based on sensing the voltage levels of the output nodes n_out1 and n_out2. In one example embodiment, the negative voltage generator 200 may perform the start-up mode operation(s) for a predetermined amount of time and then change to the normal mode. For example, the negative voltage generator 200 may perform a mode change to the normal mode after the voltages of the output nodes n_out1 and n_out2 reach the negative first input voltage −Vᵢₙ₁, and some time (e.g., a predetermined time) has elapsed. In an example embodiment, the negative voltage generator 200 may repeat the operations (e.g., the first operation (phase 1) and the second operation (phase 2)) (or the operation section) in the start-up mode a predetermined number of times, and then change to the normal mode. For example, the negative voltage generator 200 may repeat the operation(s) of the first operation and the operation(s) of the second operation a predetermined number of times, and then perform the operation(s) of the normal mode.

A first operation may be performed from the tenth time point t10 to the eleventh time point t11 (e.g., phase 1, or a first operation period). In the first operation, the start-up switch signals S1, S2 may be at the logical high level. In the first operation, the first to fifth switch signals SS1- SS5 may be at the logical low level. In the first operation, the sixth switch signal SS6 and the eighth switch signal SS8 may be at the logical low level, and the seventh switch signal SS7 may be at the logical low level. The switches SW1-SW8, SSW1, SSW2 of the negative voltage generator 200 may operate as shown in FIG. 9A in the first operation.

Referring to FIGS. 8 and 9A, in the first operation, the third node n3 may be connected to the third input node n_in3 via the first start-up switch SSW1, and the fourth node n4 may be connected to a ground node via the second start-up switch SSW2. In the first operation, the level of the third node voltage Vₙ₃ may be the level of the first input voltage Vᵢₙ₁, and the level of the fourth node voltage Vₙ₄ may be the ground voltage level. Therefore, in the first operation, the second capacitor C2 may accumulate electric charges corresponding to the first input voltage Vᵢₙ₁.

A second operation may be performed from the eleventh time point t11 to the twelfth time point t12 (e.g., phase 2, or a second operation period). In the second operation, the start-up switch signals S1, S2 may be at the logical low level. In the second operation, the first to fifth switch signals SS1-SS5 may be at the logical low level. In the second operation, the sixth switch signal SS6 and the eighth switch signal SS8 may be at the logical high level, and the seventh switch signal SS7 may be at the logical low level. The switches SW1-SW8, SSW1, SSW2 of the negative voltage generator 200 may operate as shown in FIG. 9B in the second operation.

Referring to FIGS. 8 and 9B, in the second operation, the third node n3 may be connected to the ground node via a sixth switch SW6, the fourth node n4 may be connected to a first output node n_out1 via a seventh switch SW7, and may be connected to second output node n_out2 via an eighth switch SW8. In the second operation, the levels of the fourth node voltage Vₙ₄ and the output voltages Vₒᵤₜ₁ and Vₒᵤₜ₂ may all be the same. The level of the fourth node voltage Vₙ₄ and the output voltages Vₒᵤₜ₁, Vₒᵤₜ₂ may be the first intermediate voltage VM1 from the eleventh time point t11 to the twelfth time point t12. The level of the fourth node voltage Vₙ₄ and the output voltages Vₒᵤₜ₁ and Vₒᵤₜ₂ may differ from the negative first input voltage −Vᵢₙ₁ from the eleventh t11 to twelfth t12 as the charge stored in one capacitor is distributed across the three capacitors.

The first operation may be performed again from the twelfth time point t12 to the thirteenth time point t13 . The negative voltage generator 200 may operate from the twelfth time point t12 to the thirteenth time point t13, the same as or similar to the operation(s) performed from the tenth time point t10 to the eleventh time point t11. From the twelfth time point t12 to the thirteenth time point t13, the level of the third node voltage Vₙ₃ may be the level of the first input voltage Vᵢₙ₁, and the output voltages Vₒᵤₜ₁, Vₒᵤₜ₂ may maintain the first intermediate voltage VM1. The level of the fourth node voltage Vₙ₄ may be the ground voltage level from the twelfth time point t12 to the thirteenth time point t13. This is because the fourth node n4 is connected to the ground node via the second start-up switch SSW2.

The second operation may be performed again from the thirteenth time point t13 to the fourteenth time point t14. The negative voltage generator 200 may operate at the 13th time point t13 to the 14th time point t14, the same as or similar to the operation(s) of the eleventh time point t11 to the twelfth time point t12. From the twelfth time point t12 to the thirteenth time point t13, the third node n3 may be connected to the ground node via the sixth switch SW6, and the level of the third node voltage Vₙ₃ may be the ground voltage level. The level of the fourth node voltage Vₙ₄ and the output voltages Vₒᵤₜ₁, Vₒᵤₜ₂ may be the second intermediate voltage VM2 from the thirteenth time point t13 to the fourteenth time point t14, and the second intermediate voltageVM2 may have a lower level than the first intermediate voltage VM1.

The negative voltage generator 200 may repeat the first operation and the second operation one or more times from a fourteenth time point t14 to a fifteenth time point t15. Although FIG. 8 is described with reference to the negative voltage generator 200 performing the operation(s) of the first operation and the second operation three times or more in the start-up mode, this is illustrative and example embodiments are not limited thereto. In an example embodiment, the level of the fourth node voltage Vₙ₄ and the output voltages Vₒᵤₜ₁, Vₒᵤₜ₂may be equal to the level of the negative first input voltage −Vᵢₙ₁ before or immediately before the fifteenth time point t15.

In an example embodiment, the negative voltage generator 200 may perform the first operation or the second operation for a predetermined time in the start-up mode, and then change the operation (e.g., proceed to the next operation). For example, the negative voltage generator 200 may perform the first operation for a predetermined amount of time and then change to the second operation. In an example embodiment, the controller may control the negative voltage generator 200 to change operations in a start-up mode. The negative voltage generator 200 may apply a negative first input voltage −Vᵢₙ₁ to the output nodes n_out1 and n_out2 based on the start-up mode operations of FIG. 8.

The on-off of the switches SW1-SW4 of the first stage 210 in FIGS. 9A and 9B are provided as examples, and example embodiments are not limited thereto. For example, according to an example embodiment, at least a part of the switches SW1-SW4 of the first stage 210 of FIGS. 9A and 9B may be turned on.

A third operation may be performed from the fifteenth time point t15 to the sixteenth time point t16 (e.g., phase 3, or a third operation period). In the third operation, the start-up switch signals S1, S2 may be at the logical low level. In the third operation, the first switch signal SS1 and the third switch signal SS3 may be at the logical high level, and the second switch signal SS2 and the fourth switch signal SS4 may be at the logical low level. In the third operation, the fifth switch signal SS5 and the seventh switch signal SS7 may be at the logical high level, and the sixth switch signal SS6 and the eighth switch signal SS8 may be at the logical low level. The switches SW1-SW8, SSW1, SSW2 of the negative voltage generator 200 may operate, in the third operation, as shown in FIG. 9C.

Referring to FIGS. 8 and 9C, in the third operation, the first node n1 may be connected to the first input node n_in1 via the first switch SW1, and the second node n2 may be connected to the ground node via the third switch SW3. In the third operation, the third node n3 may be connected to the second input node n_in2 via a fifth switch SW5, and the fourth node n4 may be connected to a first output node n_out1 via the seventh switch SW7. In the third operation, the first capacitor C1 may accumulate electric charges corresponding to the first input voltage Vᵢₙ₁, and the second capacitor C2 may accumulate electric charges corresponding to a sum of the first input voltages Vᵢₙ₁ and the second input voltages Vᵢₙ₂, i.e., Vᵢₙ₁+Vᵢₙ₂.

In the third operation, the level of the first node voltage Vₙ₁ may be a level of the first input voltage Vᵢₙ₁, and the level of the second node voltage Vₙ₂ may be a ground voltage level. In the third operation, the level of the third node voltage Vₙ₃ may be a level of the second input voltage Vᵢₙ₂, and the level of the fourth node voltage Vₙ₄ may be a level (e.g., at the fifteenth time point t15) of the negative first input voltage −Vᵢₙ₁, which is the level of the first output voltage Vₒᵤₜ₁. The second output voltage Vₒᵤₜ₂ may be a level of the negative first input voltage −Vᵢₙ₁ from the fifteenth time point t15 to the sixteenth time point t16 as it is not connected to another node.

A fourth operation may be performed from the sixteenth time point t16 to the seventeenth time point t17 (e.g., phase 4, or a fourth operation period). In the fourth operation, the start-up switch signals S1, S2 may be at the logical low level. In the fourth operation, the first switch signal SS1 and the third switch signal SS3 may be at the logical low level, and the second switch signal SS2 and the fourth switch signal SS4 may be at the logical high level. In the fourth operation, the fifth switch signal SS5 and the seventh switch signal SS7 may be at the logical low level, and the sixth switch signal SS6 and the eighth switch signal SS8 may be at the logical high level. The switches SW1-SW8, SSW1, SSW2 of the negative voltage generator 200 may operate, in the fourth operation, as shown in FIG. 9D.

Referring to FIGS. 8 and 9D, in the fourth operation, the first node n1 may be connected to the ground node via the second switch SW2, and the second node n2 may be connected to a first output node n_out1 via the fourth switch SW4. In the fourth operation, the third noden3 may be connected to the ground node via the sixth switch SW6, and the fourth node n4 may be connected to a second output node n_out2 via the eighth switch SW8.

In the fourth operation, the level of the first node voltage Vₙ₁ may be the ground voltage level, and the level of the second node voltage Vₙ₂ may be the level of the negative first input voltage −Vᵢₙ₁. In the fourth operation, the level of the third node voltage Vₙ₃ may be a ground voltage level, and the level of the fourth node voltage Vₙ₄ may be a level of a sum of the negative first input voltage −Vᵢₙ₁ and the negative second input voltage − Vᵢₙ₂, i.e., − (Vᵢₙ₁+Vᵢₙ₂). In the fourth operation, as the first output node n_out1 is connected to the second node n2, the level of the first output voltage Vₒᵤₜ₁ may be a level of the negative first input voltage −Vᵢₙ₁. In the fourth operation, as the second output node n_out2 is connected to the fourth node n4, the level of the second output voltage Vₒᵤₜ₂ may be a level of a sum of the negative first input voltage −Vᵢₙ₁ and the negative second input voltage − Vᵢₙ₂, i.e., − (Vᵢₙ₁+Vᵢₙ₂).

The third operation may be performed again from the seventeenth time point t17 to the eighteenth time point t18. The negative voltage generator 200 may operate the same as or similar to the operation(s) of the fifteenth time point t15 to the sixteenth time point t16. As the second output node n_out2 is not connected to the fourth node n4 at the seventeenth time point t17 to the eighteenth time point t18, the second output voltage Vₒᵤₜ₂ may maintain the level of the second output voltage Vₒᵤₜ₂ in the sixteenth time point t16 to the seventeenth point t17. The eighteenth time point t18 to the nineteenth time point t19 may be the fourth operation, and the negative voltage generator 200 may operate the same as or similar to the operation(s) of the sixteenth time point t16 to the seventeenth time point t17. In an example embodiment, the negative voltage generator 200 may repeat the operation(s) of the third operation and the fourth operation after the nineteenth time point t19.

In an example embodiment, the negative voltage generator 200 may perform the third operation or the fourth operation for a predetermined time in the normal mode, and then change the operation (e.g., next operation). For example, the negative voltage generator 200 may perform the operation(s) of the third operation for a predetermined time, and then change to the fourth operation. In an example embodiment, the controller may control the negative voltage generator 200 to change operations in a normal mode. In an example embodiment, the negative voltage generator 200 may repeat the operation(s) of the third operation and the fourth operation a predetermined number of times.

The change of the second output voltage Vₒᵤₜ₂ in the normal mode shown in FIG. 8 is exemplary, and example embodiments are not limited thereto. In an example embodiment, the negative voltage generator 200 may repeat the operation(s) of the third operation and the fourth operation a plurality of times to cause the level of the second output voltage Vₒᵤₜ₂ to have a sum of the negative first input voltage and the negative second input voltage –(Vᵢₙ₁+Vᵢₙ₂), and may then maintain the level of the second output voltage Vₒᵤₜ₂, based on the third operation, and the fourth operation being repeatedly performed a plurality of times. For example, the second output voltage Vₒᵤₜ₂ may decrease (e.g., gently or in the form of a step) to reach the sum of the negative first input voltage and the negative second input voltage −(Vᵢₙ₁+Vᵢₙ₂) according to (repeating of) the operation(s) of the third operation and the fourth operation.

The operation of the negative voltage generator 200 described with reference to FIGS. 8 and 9A-9D is illustrative and should not be construed as limiting the scope of the invention to the graphs shown, and it should be understood that at least some of the graphs of FIG. 8 may be shown with some exaggeration for ease of description. It should be understood that according to some an example embodiments, the level change of each of the switch signals, the on-off of each of the switches, or the change form or waveform of each of the voltage levels may change differently from the those shown in FIG. 8. For example, according to an example embodiment, voltage level(s) may change more slowly than the change of the voltage level(s) illustrated in FIG. 8. For example, although FIG. 8 shows that the level of the fourth node voltage Vₙ₄ or the output voltages Vₒᵤₜ₁, Vₒᵤₜ₂ changes immediately according to an on-off change of each of the switches, it should be understood that according to some example embodiments, at least one of voltage levels (e.g., levels of the output voltages Vₒᵤₜ₁, Vₒᵤₜ₂or the fourth node voltage Vₙ₄) may change more slowly than those shown in FIG. 8. In FIG. 8, the time points t11-t19 are intended to indicate the order of the operation(s), and it should be understood that the interval between the time points t11-t19 does not necessarily correspond to the actual time at which the operation is performed. For example, the time required for the first operation and the time required for the second operation may be the same, or either one may be longer. For another example, the time required for the operation(s) of the third operation and the time required for operation(s) of the fourth operation may be the same, or either one may be longer.

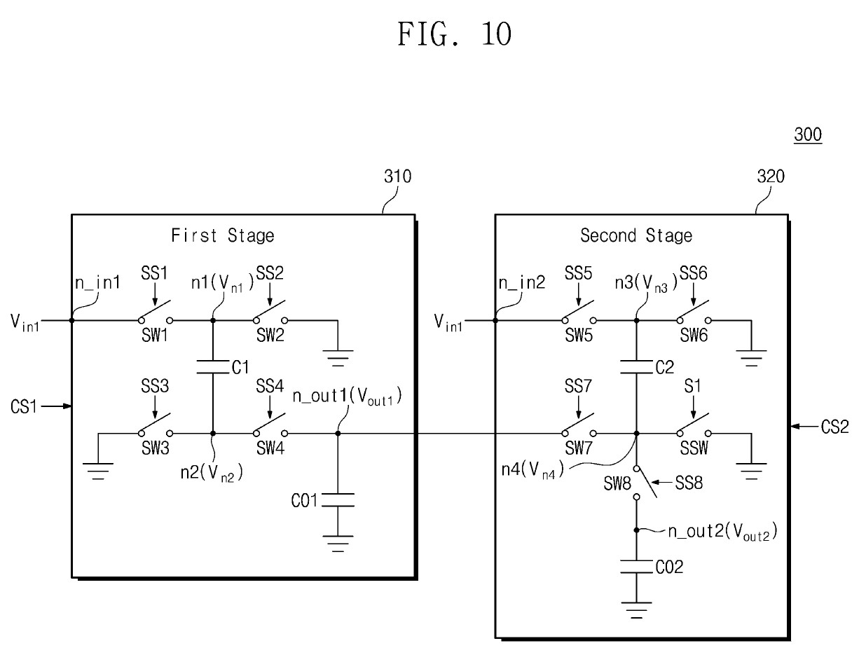

FIG. 10 is a circuit diagram of a negative voltage generator in detail, in accordance with an example embodiment. Referring to FIG. 10, the negative voltage generator 300 may include a first stage 310 and a second stage 320. The first stage 310 and the second stage 320 may constitute a charge pump of the negative voltage generator 300. The first stage 310 and the second stage 320 may be a division for convenience of description or on function, or a role, or may not correspond to a division on physical or hardware.

Referring to FIG. 10, the first stage 310 may include first to fourth switches SW1-SW4, a first capacitor C1, and a first output capacitor CO1. The first stage 310 may be the same as or similar to the first stage 210 of FIG. 4, and may include the same or similar configuration(s). The first stage 310 may operate the same or similar to the operation(s) of the first stage 210 described through FIGS. 4-8, and 9A-9D.

The second stage 320 may include fifth to eighth switches SW5-SW8, a start-up switch SSW, a second capacitor C2, and a second output capacitor CO2. The fifth switch SW5 may be connected between the second input noden_in2 and the third node n3, and may operate in response to a fifth switch signal SS5. The first input voltage Vᵢₙ₁ may be applied through the second input node n_in2. The sixth switch SW6 may be connected between the third node n3 and the ground node, and may operate in response to the sixth switch signal SS6. The voltage of the third node n3 may be the third node voltage Vₙ₃.

The seventh switch SW7 may be connected between the first output node n_out1 and the fourth node n4, and may operate in response to a seventh switch signal SS7. The eighth switch SW8 may be connected between the fourth node n4 and the second output node n_out2 and may operate in response to an eighth switch signal SS8. The voltage of the fourth node n4 may be the fourth node voltage Vₙ₄. The second capacitor C2 may be connected between the third node n3 and the fourth node n4. The second output capacitor CO2 may be connected between the second output noden_out2 and the ground node. The start-up switch SSW may be connected between the fourth node n4 and the ground node, and may operate in response to the first start-up switch signal S1.

The first stage 310 may generate the first output voltage Vₒᵤₜ₁ based on the first input voltage Vᵢₙ₁ in response to the first control signal CS1. The first control signal CS1 may be a signal generated by a controller (e.g., a controller that controls a charge pump) of the negative voltage generator 300. In an example embodiment, the first output voltage Vₒᵤₜ₁ may be or correspond to a negative first input voltage −Vᵢₙ₁. That is, the level of the first output voltage Vₒᵤₜ₁ may be equal in magnitude to the level of the first input voltage Vᵢₙ₁, and may be opposite in sign. The second stage 320 may generate the second output voltage Vₒᵤₜ₂ based on the first input voltage Vᵢₙ₁ in response to the second control signal CS2. The second control signal CS2 may be a signal generated by a controller (e.g., a controller that controls a charge pump) of the negative voltage generator 100.

The second stage 320 may include only one start-up switch, unlike the second stage 220 of FIG. 4. The second stage 320 may operate similarly to the second stage 220 of FIGS. 4-8, and 9A-9D. In an example embodiment, the second stage 320 may operate similarly to the start-up mode of the second stage 220 described through FIGS. 4-8, 9A, and 9B. For example, the second stage 320 may operate similarly to the first operation of FIG. 8, and in this case, the fifth switch SW5 and the start-up switch SSW may be in a turn-on state, and the sixth to eighth switches SW6 to SW8 may be in a turned-off state. For example, the second stage 320 may operate similarly to the second stage of FIG. 8 following the first stage, and in this case, the fifth switch SW5 and the start-up switch SSW may be in a turn-off state, and the sixth to eighth switches SW6 to SW8 may be in a turned-on state.

In an example embodiment, the second stage 320 may operate similarly to the third and fourth operations of FIG. 8. For example, the fifth to eighth switches SW5 to SW8 may operate in the normal mode in the same manner as the states of the fifth to eighth switches SW5-SW8 in the normal mode of FIG. 8, 9C, and 9D. In this case, the start-up switch SSW may be in a turn-off state. That is, the fifth switch SW5 of FIG. 10 may perform the operation (s) or the role (s) of the first start-up switch SSW1 or the fifth switch SW 5 of FIGS. 4-8, and 9A-9D in the same or similar manner. In an example embodiment, the second output voltage Vₒᵤₜ2 may be a double negative first input voltage −2Vin1.

Although the first stage 310 is shown and described in FIG. 10 as including the first output node n_out1 and the first output capacitor CO1, this is illustrative and it should be understood that an example embodiment in which the first output node n_out1 or first output capacitor CO1 is located outside the first stage 310 is also within the scope of the present invention. Similarly, while the second stage 320 is shown and described in FIG. 2 as including the second output node n_out2 and the second output capacitor CO2, this is illustrative and according to some example embodiments the second output node n_out2 or second output capacitor CO2 may be located outside the second stage 320. Although FIG. 10 describes an example in which the first input node n_in1 and the second input node n_in2 receive the same input voltages (e.g., the first input voltage Vᵢₙ₁), example embodiments are not limited thereto, and it should be understood that example embodiments in which the levels of voltages applied to each of the input nodes n_in1 and n_in2 are different are also within the scope of the invention.

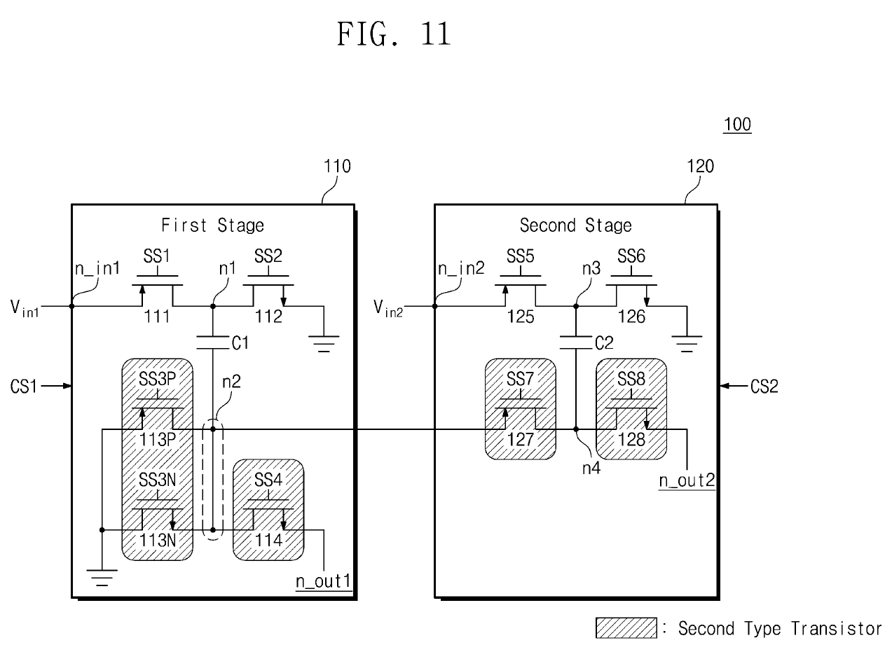

FIG. 11 is a circuit diagram of an example of a detailed implementation of the negative voltage generator of FIG. 2, in accordance with an example embodiment. Referring to FIG. 11, the negative voltage generator 100 may include a first stage 110 and a second stage 120, the first stage 110 may include first to fourth transistors 111-114 and a first capacitor C1, and the second stage 120 may include fifth to eighth transistors 125-128 and a second capacitor C2. A detailed implementation example of the negative voltage generator 100 is described with reference to FIG. 11.

The first transistor 111 may be connected between the first node n1 and the first input noden_in1, and may operate in response to the first switch signal SS1. For example, the first transistor 111 may be a p-type metal-oxide-semiconductor transistor (PMOS transistor) connected between the first node n1 and the first input node n_in1 and may operate in response to the first switch signal SS1. The first transistor 111 may be, or may be included in, the first switch SW1 of FIG. 2.

The second transistor 112 may be connected between the first node n1 and the ground node, and may operate in response to the second switch signal SS2. For example, the second transistor 112 may be an n-type MOS transistor (NMOS transistor) connected between the first node n1 and the ground node and may operate in response to the second switch signal SS2. The second transistor 112 may be, or may be included in, the second switch SW2 of FIG. 2.

The third switch SW3 of FIG. 2 may include a third N transistor 113N and a third P transistor 113P. In an example embodiment, the third switch SW3 may improve an output characteristic (e.g., a resistance characteristic) of the first stage 110 based on further including a third P transistor 113P in addition to the third N transistor 113N. The third N transistor 113N may be an NMOS transistor connected between the second node n2 and the ground node and may operate in response to the third N switch signal SS3N. The third P transistor 113P may be a PMOS transistor connected between the second node n2 and the ground node and may operate in response to the third P switch signal SS3P. The third switch signal SS3 may include a third P switch signal SS3P and a third N switch signal SS3N.

The fourth transistor 114 may be connected between the first output node n_out1 and the second node n2, and may operate in response to the fourth switch signal SS4. For example, the fourth transistor 114 may be an NMOS transistor connected between the first output node n_out1 and the second node n2. The fourth transistor 114 may be, or may be included in, the fourth switch SW4 of FIG. 2.

Each of the first switch signals SS1, SS2, SS3P, SS3N, and SS4 may change in response to the first control signal CS1. For example, each of the first switch signals SS1, SS2, SS3P, SS3N, and SS4 may have the logical high level or the logical low level in response to the first control signal CS1. In some example embodiments, each of the first transistors 111, 112, 113P, 113N, 114 may be turned on in response to the corresponding switch signal being at the logical high level, but example embodiments are not limited thereto. According to some example embodiments at least some or all of the first transistors 111, 112, 113P, 113N, 114 may be turned on in response to the corresponding switch signal being at the logical low level.

The fifth transistor 125 may be connected between the third node n3 and the second input node n_in2 and may operate in response to the fifth switch signal SS5. For example, the fifth transistor 125 may be a PMOS transistor connected between the third node n3 and the second input node n_in2 and may operate in response to the fifth switch signal SS5. The fifth transistor 125 may be, or may be included in, the fifth switch SW5 of FIG. 2.

The sixth transistor 126 may be connected between the third node n3 and the ground node and may operate in response to the sixth switch signal SS6. For example, the sixth transistor 126 may be an NMOS transistor connected between the third node n3 and the ground node and may operate in response to the sixth switch signal SS6. The sixth transistor 126 may be, or may be included in, the sixth switch SW6 of FIG. 2.

The seventh transistor 127 may be connected between the second node n2 and the fourth node n4 and operate in response to the seventh switch signal SS7. For example, the seventh transistor 127 may be a PMOS transistor connected between the second node n2 and the fourth node n4 and may operate in response to the seventh switch signal SS7. The seventh transistor 127 may be, or may be included in, the seventh switch SW7 of FIG. 2.

The eighth transistor 128 may be connected between the fourth node n4 and the second output node n_out2, and may operate in response to the eighth switch signal SS8. For example, the eighth transistor 128 may be an NMOS transistor connected between the fourth node n4 and the second output node n_out2 and may operate in response to the eighth switch signal SS8. The eighth transistor 128 may be, or may be included in, the eighth switch SW8 of FIG. 2. The first capacitor C1 may be connected between the first node n1 and the second node n2, and the second capacitor C2 may be connected between the third node n3 and the fourth node n4.

Each of the second switch signals SS5, SS6, SS7, and SS8 may change in response to the second control signal CS2. For example, each of the second switch signals SS5, SS6, SS7, and SS8 may have the logical high level or the logical low level in response to the second control signal CS2. In an example embodiment, each of the second transistors 125-128 may be turned on in response to the corresponding switch signal being at logical high level, but example embodiments are not limited thereto. According to an example embodiment, at least some or all of the second transistors 125 to 128 may be turned on in response to the corresponding switch signal being at logical low level.

In an example embodiment, the negative voltage generator 100 may include two types of transistors. For example, the first transistor 111, the second transistor 112, the fifth transistor 125, and the sixth transistor 126 may be first-type transistors, and the third P transistor 113P, the third N transistor 113N, the fourth transistor 114, the seventh transistor 127, and the eighth transistor 128 may be second-type transistors. Here, for a more detailed example, the first type transistor may be a medium voltage transistor (MV transistor), and the second type transistor may be the high voltage transistor (HV transistor). For example, the MV transistor may have a switching speed that is faster than that of the HV transistor. For example, the MV transistor may have a voltage rating that is lower than that of the HV transistor. For example, the MV transistor may be smaller than the HV transistor. For example, the MV transistor may have a lower resistance than the HV transistor. It is illustrative and should not be construed that each of the transistors in FIG. 11 is shown and described as a p-type or n-type transistor, and example embodiments in which type(s) of at least some of the transistors are implemented differently from types (p type or n type) of those shown in FIG. 11 respectively, is also within the scope of the present invention. switching speed

In an example embodiment, a body of the third P transistor 113P, the third N transistor 113N, the fourth transistor 114, the seventh transistor 127, and the eighth transistor 128 may be connected to a substrate, and the second output voltage Vₒᵤₜ₂ (, which may be –(Vᵢₙ₁+Vᵢₙ₂)) may be applied to the substrate. In this case, as the voltage difference between the corresponding switch signal and the body is large, the third P transistor 113P, the third N transistor 113N, the fourth transistor 114, the seventh transistor 127, and the eighth transistor 128 may be implemented as HV transistors. In the case of the HV transistor, the size of the negative voltage generator 100 may be increased by a larger size than that of the MV transistor, and the operation characteristics (e.g., response speed or output resistance characteristics) may be poor.

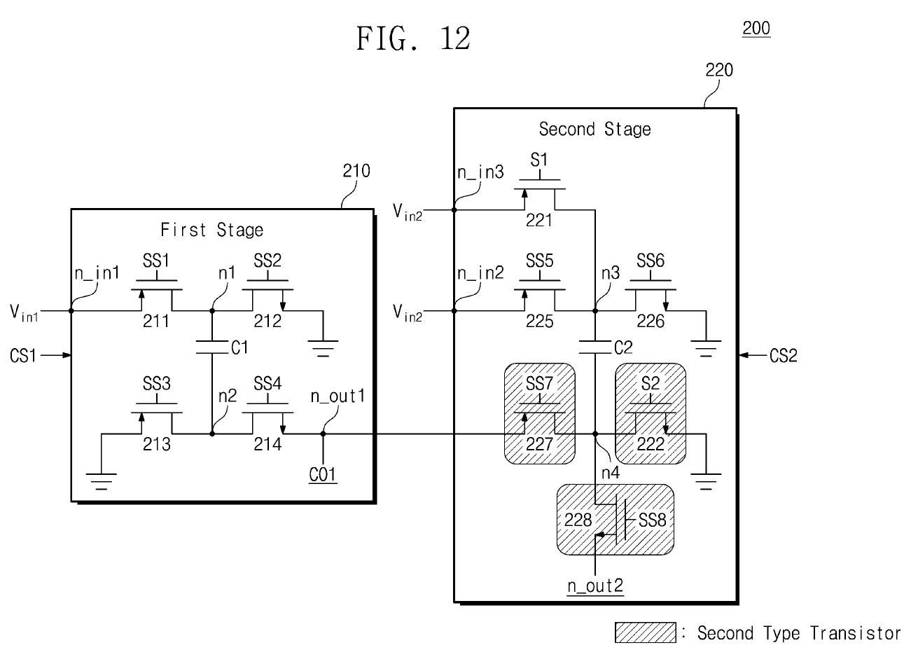

FIG. 12 is a circuit diagram of an example of a detailed implementation of the negative voltage generator of FIG. 4, in accordance with an example embodiment. Referring to FIG. 12, the negative voltage generator 200 may include the first stage 210 and the second stage 220, the first stage 210 may include first to fourth transistors 211-214 and a first capacitor C1, and the second stage 220 may include fifth to eighth transistors 225-228, a first start-up transistor 221, a second start-up transistors 222, and a second capacitor C2. Detailed illustration of the implementation of the negative voltage generator 200 is described with reference to FIG. 12.

The first transistor 211 may be connected between the first node n1 and the first input node n_in1, and may operate in response to the first switch signal SS1. For example, the first transistor 211 may be a p-type metal-oxide-semiconductor transistor (PMOS transistor) connected between the first node n1 and the first input node n_in1 and may operate in response to the first switch signal SS1. The first transistor 211 may be, or may be included in, the first switch SW1 of FIG. 4.

The second transistor 212 may be connected between the first noden1 and the ground node, and may operate in response to the second switch signal SS2. For example, the second transistor 212 may be an n-type MOS transistor (NMOS transistor) connected between the first node n1 and the ground node and may operate in response to the second switch signal SS2. The second transistor 212 may be, or may be included in, the second switch SW2 of FIG. 4.

The third transistor 213 may be connected between the second node n2 and the ground node, and may operate in response to the third switch signal SS3. For example, the third transistor 213 may be a PMOS transistor connected between the second node n2 and the ground node and may operate in response to the third switch signal SS3. In an example embodiment, the third switch signal SS3 may be generated based on the first output voltage Vₒᵤₜ₁. For example, the third switch signal SS3 may be generated based on the first output voltage Vₒᵤₜ₁, and the level of the voltage between the gate and the body of the third transistor 213 may be smaller than the level of the voltage between the gate and body of the third N transistor 113N of FIG. 11. (In the case of the third-N switch signal SS3N in FIG. 11, because there is no operation of the start-up mode described with reference to FIGS. 4-8, and 9A-9D, the third-N switching signal SS3N may be generated based on the first input voltage Vᵢₙ₁ instead of the first output voltage Vₒᵤₜ₁, and a difference in voltage between a gate and a body (e.g., a substrate having a level of the second output voltage Vₒᵤₜ₂) of the third- N transistor 113N may be very large.) The third transistor 213 may be, or may be included in, the third switch SW3 of FIG. 4.

The fourth transistor 214 may be connected between the first output node n_out1 and the second node n2, and may operate in response to the fourth switch signal SS4. For example, the fourth transistor 214 may be an NMOS transistor connected between the first output node n_out1 and the second node n2. The fourth transistor 214 may be, or may be included in, the fourth switch SW4 of FIG. 4.

Each of the first switch signals SS1-SS4 may change in response to the first control signal CS1. For example, each of the first switch signals SS1-SS4 may have the logical high level or the logical low level in response to the first control signal CS1. In an example embodiment, each of the first transistors 211-214 may be turned on in response to the corresponding switch signal being at logical high level, but example embodiments are not limited thereto. According to an example embodiment, at least some or all of the first transistors 211-214 may be turned on in response to the corresponding switch signal being at logical low level.

The fifth transistor 225 may be connected between the third node n3 and the second input node n_in2 and operate in response to the fifth switch signal SS5. For example, the fifth transistor 225 may be a PMOS transistor connected between the third noden3 and the second input node n_in2 and may operate in response to the fifth switch signal SS5. The fifth transistor 225 may be, or may be included in, the fifth switch SW5 of FIG. 4.

The sixth transistor 226 may be connected between the third node n3 and the ground node and operate in response to the sixth switch signal SS6. For example, the sixth transistor 226 may be an NMOS transistor connected between the third node n3 and the ground node and may operate in response to the sixth switch signal SS6. The sixth transistor 226 may be, or may be included in, the sixth switch SW6 of FIG. 4.

The seventh transistor 227 may be connected between the first output node n_out1 and the fourth noden4 and may operate in response to the seventh switch signal SS7. For example, the seventh transistor 227 may be a PMOS transistor connected between the first output noden_out1 and the fourth node n4 and may operate in response to the seventh switch signal SS7. The seventh transistor 227 may be, or may be included in, the seventh switch SW7 of FIG. 4.

The eighth transistor 228 may be connected between the fourth node n4 and the second output node n_out2, and may operate in response to the eighth switch signal SS8. For example, the eighth transistor 228 may be an NMOS transistor connected between the fourth node n4 and the second output node n_out2 and may operate in response to the eighth switch signal SS8. The eighth transistor 228 may be, or may be included in, the eighth switch SW8 of FIG. 4.

The first start-up transistor 221 may be connected between the third noden3 and the third input node n_in3, and may operate in response to the first start-up switch signal S1. For example, the first start-up transistor 221 may be a PMOS transistor connected between the third node n3 and the third input node n_in3 and may operate in response to the first start-up switch signal S1. The first start-up transistor 221 may be, or may be included in, the first start-up switch SSW1 of FIG. 4.

The second start-up transistor 222 may be connected between the fourth node n4 and the ground node, and may operate in response to the second start-up switch signal S2. For example, the second start-up transistor 222 may be an NMOS transistor connected between the fourth node n4 and the ground node and may operate in response to the second start-up switch signal S2. The second start-up transistor 222 may be, or may be included in, the second start-up switch SSW2 of FIG. 4. The first capacitor C1 may be connected between the first node n1 and the second node n2, and the second capacitor C2 may be connected between the third node n3 and the fourth node n4.

Each of the second switch signals SS5-SS8 and the start-up switch signals S1, S2 may change in response to the second control signal CS2. For example, each of the second switch signals SS5-SS8 and the start-up switch signals S1, S2 may have the logical high level or the logical low level in response to the second control signal CS2. In an example embodiment, each of the second transistors 225-228 and the start-up transistors 221, 222 may be turned on in response to the corresponding switch signal being at logical high level, but example embodiments are not limited thereto. According to some example embodiments, at least some or all of the second transistors 225-228 and the start-up transistors 221, 222 may be turned on in response to the corresponding switch signal being at logical low level.

In an example embodiment, the negative voltage generator 200 may include two types of transistors. For example, the first transistors 211-214, the fifth transistor 225, the sixth transistor 226, and the first start-up transistor 221 may be a first type transistor, and the seventh transistor 227, the eighth transistor 228, and the second start-up transistor 222 may be a second type transistor. For a more detailed example, the first type transistor may be a medium voltage transistor (MV transistor), and the second type transistor may be the high voltage transistor (HV transistor).

As the voltage level of the first output node n_out1 is the level of the negative first input voltage −Vᵢₙ₁, and the level difference between the third switch signal SS3 generated based on the voltage of the first output nodes n_out1 and the voltage of the substrate of the third transistor 213 is small, unlike the implementation of the third switch SW3 in FIG. 11, the third switch SW2 may be implemented with only one MV transistor. It is illustrative and should not be construed that each of the transistors in FIG. 12 is shown and described as a p-type or n-type transistor, and example embodiments in which type(s) of at least some of the transistors are implemented differently from types (p type or n type) of those shown in FIG. 12 respectively, is also within the scope of the present invention.

The first stage 210 of FIG. 12 may include only the first type of transistors (i.e., MV transistors), based on the structure of FIGS. 4-8, and 9A-9D. As the first stage 210 of FIG. 12 includes only MV transistors, it can be implemented in a smaller size than the first stage 110 of FIG. 11, and the operation speed can also be improved. In addition, the negative voltage generator 200 of FIG. 12 may be implemented in a smaller size as the number of second type transistors (i.e., HV transistors) is reduced compared to the negative voltage generator 100 of FIG. 11, and the operation speed may be further improved. The negative voltage generator 200 of FIG. 12 may improve the resistance characteristics of each of the output nodes n_out1 and n_out2 by reducing the number of second type transistors. The negative voltage generator 200 of FIG. 12 may remove charge stored in the capacitors C1 and C2 after operation of the negative voltage generator without having a separate charge discharge transistor. Thus, the negative voltage generator 200 of FIG. 12 can be miniaturized compared to the negative voltage generator 100 of FIG. 11, and can be simplified in design and manufacture, as the first stage 210 is implemented with MV transistors, and further does not include a separate structure for charge discharge.

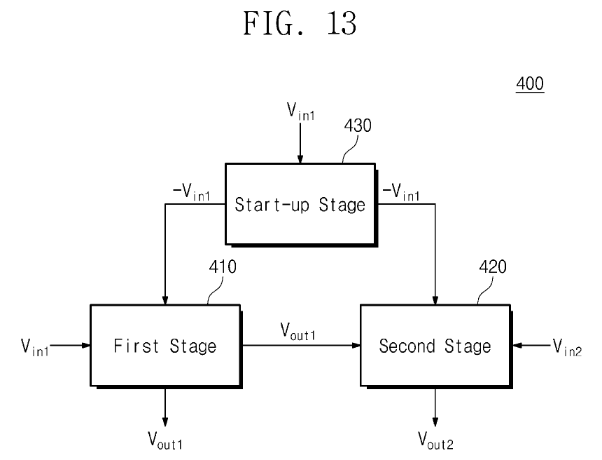

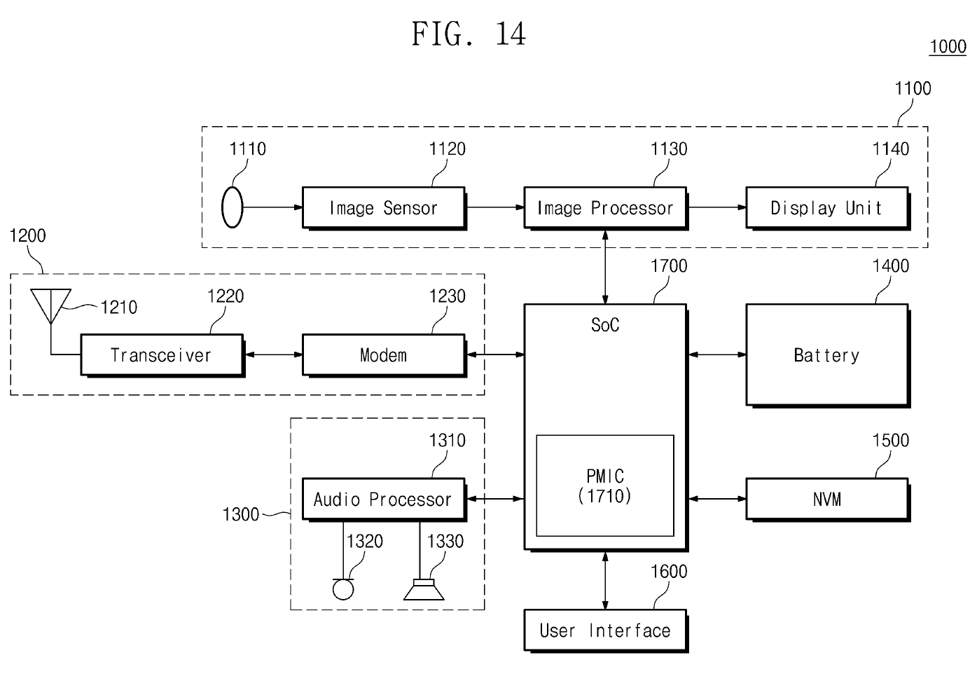

FIG. 13 is a circuit diagram of a negative voltage generator in detail, in accordance with an example embodiment. Referring to FIG. 13, the negative voltage generator 400 may include a first stage (e.g., first stage circuit) 410, a second stage(e.g., second stage circuit), and a start-up stage (e.g., start-up stage circuit) 430.

The first stage 410 may generate the first output voltage Vₒᵤₜ₁ based on the first input voltage Vin1. In an example embodiment, the first stage 410 may generate the first output voltage Vout1 further based on the negative first input voltage −Vin1 received from the start-up stage 430. In an example embodiment, the first output voltage Vout1 may have the same level as or correspond to the negative first input voltage −Vᵢₙ₁.

The first stage 410 may provide the generated first output voltage Vₒᵤₜ₁ to the second stage 420. In an example embodiment, the first stage 410 may be the same as or similar to the first stage of FIGS. 4-8, 9A-9D, and 10-12, or operate the same as or similar to, the first stage of FIGS. 4-8, 9A-9D, and 10-12.

The second stage 420 may generate the second output voltage Vout2 based on the second input voltage Vᵢₙ₂. In an example embodiment, the second stage 420 may generate the second output voltage Vₒᵤₜ₂ further based on the negative first input voltage −Vᵢₙ₁ received from the start-up stage 430 or the first output voltage Vₒᵤₜ₁ received from the first stage 410.

In an example embodiment, the second output voltage Vₒᵤₜ₂ may have or correspond to a level equal to a sum of the negative first input voltage −Vᵢₙ₁ and the negative second input voltage − Vᵢₙ₂, i.e., -(Vᵢₙ₁+Vᵢₙ₂). In an example embodiment, the second stage 420 may be the same as or similar to the second stage of FIGS. 4-8, 9A-9D, and 10-12, or operate the same as or similar to, the second stage of FIGS. 4-8, 9A-9D, and 10-12. For example, the second stage 420 may include the fifth to eighth switches SW5-SW8 and the second capacitor C2 of FIG. 4.

The start-up stage 430 may generate a negative first input voltage −Vᵢₙ₁ based on the first input voltage Vᵢₙ₁. In an example embodiment, the start-up stage 430 may operate the same as or similar to the operation of the start-up mode described in FIGS. 4-8, 9A, and 9B. The start-up stage 430 may provide the generated negative first input voltage −Vᵢₙ₁ to the first stage 410 and the second stage 420. In an example embodiment, the start-up stage 430 may include the start-up switches SSW1, SSW2, the sixth and seventh switches SW6, SW7, and the second capacitor C2 of FIGS. 4-8, 9A-9D, 10, and 12.

FIG. 14 is a block diagram illustrating an electronic device, according to an example embodiment. Referring to FIG. 14, an electronic device 1000 according to an example embodiment may include an image processing unit 1100, a wireless transceiver unit 1200, an audio processing unit 1300, a battery 1400, a non-volatile memory device 1500, a user interface 1600, and a system-on-chip (SoC) 1700. In an example embodiment, the electronic device 1000 may operate under control of the SoC 1700.

The image processing unit 1100 includes a lens 1110, an image sensor 1120, an image processor 1130, and a display unit 1140. The image processor 1130 may convert a real image into image data through the lens 1110 and the image sensor 1120. The display unit 1140 may display an image data signal generated by the image processor 1130 or image data to be provided to the user. The display unit 1140 may be implemented with a liquid crystal display (LCD), an organic light emitting diode (OLED), etc. When the LCD or the OLED is implemented in a touch screen manner, the display unit 1140 may operate together with the user interface 1600. In an example embodiment, image processor 1130 may include the negative voltage generator in FIGS. 1-8, 9A-9D, and 10-13.

The wireless transceiver unit 1200 include an antenna 1210, a transceiver 1220, and a modulator/demodulator (modem) 1230. The wireless transceiver unit 1200 may perform a wireless communication function. The transceiver 1220 may adjust a frequency of a signal to be transmitted through the antenna 1210 or may amplify the signal and may adjust a frequency of a signal received through the antenna 1210 or may amplify the signal. The modem 1230 may include a transmitter encoding and modulating a signal to be transmitted and a receiver demodulating and decoding a signal received through the antenna 1210. The antenna 1210 and the modem 1230 of the wireless transceiver unit 1200 may process signals exchanged with an external device/system, based on at least one of various wireless communication protocols: long term evolution (LTE), worldwide interoperability for microwave access (WiMax), global system for mobile communication (GSM), code division multiple access (CDMA), Bluetooth, near field communication (NFC), wireless fidelity (Wi-Fi), and radio frequency identification (RFID).

The audio processing unit 1300 includes an audio processor 1310, a microphone 1320, and a speaker 1330. The audio processing unit 1300 may constitute a codec, and the codec may include a data codec and an audio codec. The data codec may process packet data or the like, and the audio codec may process a voice and an audio signal such as a multimedia file. Also, the audio processing unit 1300 may perform a function of converting and replaying a digital audio signal received by the modem 1230 into an audio analog signal through the audio codec or converting an analog audio signal generated from the microphone 1320 into a digital audio signal so as to be transmitted to the modem 1230. The codec may be provided separately or may be included in the SoC 1700.

The battery 1400 may provide a power necessary for the operation of the electronic device 1000. In FIG. 14 the electronic device 1000 is illustrated as receiving the power from the battery 1400, but example embodiments are not limited thereto. According to an example embodiment, an external power source may provide the power. The non-volatile memory device 1500 may store data of the electronic device 1000. For example, the non-volatile memory device 1500 may be a NAND flash memory device or may include the NAND flash memory device. The non-volatile memory device 1500 may be provided as a memory card (e.g., MMC, eMMC, SD, or micro SD) according to an example embodiment. In an example embodiment, non-volatile memory device 1500 may include the negative voltage generator in FIGS. 1-8, 9A-9D, and 10-13.

The user interface 1600 may receive an input from the outside or may provide an output to the outside. For example, the user interface 1600 may receive an input through an input device such as a keyboard or a mouse. In an example embodiment, the user interface 1600 may include a driver for receiving the input from the input devices. In an example embodiment, the user interface 1600 may generate an output while operating with the display unit 1140 or the audio processing unit 1300 together.

The SoC 1700 may drive an application program or an operating system. In an example embodiment, the SoC 1700 may include a processor such as a general purpose processor or a specific purpose processor. In an example embodiment, the SoC 1700 may control the components of the electronic device 1000. The SoC 1700 may include an PMIC 1710. The PMIC 1710 may be supplied with a voltage from the battery 1400 and may convert the level of the supplied voltage. The PMIC 1710 may provide the converted voltage level to the respective components of the electronic device 1000. In an example embodiment, SoC 1700 may include the negative voltage generator in FIGS. 1-8, 9A-9D, and 10-13.

The components of the electronic device 1000 illustrated in FIG. 14 are provided as an example, and example embodiments are not limited thereto. For example, according to some example embodiments the electronic device 1000 may further include a volatile memory device as a system memory, and the volatile memory device may operate under control of the SoC 1700. In an example embodiment, the electronic device 1000 may not include some of the components of FIG. 14. For example, the electronic device 1000 may not include the image processing unit 1100. The components described as including the negative voltage generator in FIGS. 1-8, 9A-9D, and 10-13 are illustrative, and according to some example embodiments at least some of the components not referred to above may include the negative voltage generator in FIGS. 1-8, 9A-9D, and 10-13.

As used herein, components which are described with reference to terms “block”, “~er or ~or”, “circuit or circuitry”, etc. and function blocks which are illustrated in drawings may be implemented with hardware, and the hardware may execute software instructions. In an example embodiment, the software instructions may be or include machine code, firmware, embedded code, source code, application software, a combination thereof and/or the like. In an example embodiment, the hardware may be or include an electrical circuit, an electronic circuit (e.g., an analog circuit or a digital circuit), a processor, a computer, an integrated circuit, integrated circuit cores, a pressure sensor, an inertial sensor, a microelectromechanical system (MEMS), a passive element, a combination thereof, and/or the like.

While aspects of example embodiments have been particularly shown and described, it will be understood that various changes in form and details may be made therein without departing from the spirit and scope of the following claims.

What is claimed is:

1. A voltage generator comprising:
a first stage circuit configured to receive a first input voltage via a first input node, and output, based on the first input voltage, a first output voltage via a first output node; and
a second stage circuit configured to receive the first input voltage via a second input node, receive a second input voltage via a third input node, and output, based on the first and second input voltages, a second output voltage via a second output node,
wherein the second stage circuit comprises:
a first start-up switch configured to connect the second input node and a first node;
a second start-up switch configured to connect a ground node and a second node;
a first switch configured to connect the third input node and the first node;
a second switch configured to connect the first node and the ground node;
a third switch configured to connect the second node and the first output node;
a fourth switch configured to connect the second node and the second output node; and
a first capacitor connected between the first node and the second node.

2. The voltage generator of claim 1, wherein the first output voltage is equal in magnitude to the first input voltage and opposite in sign to the first input voltage, and
wherein the second output voltage is equal in magnitude to a sum of the first input voltage and the second input voltage, and opposite in sign to the sum.

3. The voltage generator of claim 1, wherein the first stage circuit comprises:
a fifth switch configured to connect the first input node and a third node;
a sixth switch configured to connect the third node and the ground node;
a seventh switch configured to connect a fourth node and the ground node;
an eighth switch configured to connect the fourth node and the first output node; and
a second capacitor connected between the third node and the fourth node.

4. The voltage generator of claim 1, wherein the first stage circuit is configured to output the first output voltage based on the first input voltage in response to a first control signal, and
wherein the second stage circuit is configured to generate the first output voltage, and output the second output voltage, in response to a second control signal.

5. The voltage generator of claim 4, wherein the second stage circuit is further configured to:
selectively operate in a start-up mode and a normal mode, and
while operating in the start-up mode:
during a first operation period, perform a first operation comprising controlling to turn on the first start-up switch and the second start-up switch, and turn off the second switch, the third switch, and the fourth switch, and
during a second operation period, perform a second operation comprising controlling to turn off the first start-up switch and the second start-up switch, and turn on the second switch, the third switch, and the fourth switch.

6. The voltage generator of claim 5, wherein the second stage circuit is further configured to:
operate operates in the normal mode after the start-up mode, and
while operating in the normal mode:
during a third operation period, perform a third operation comprising controlling to turn on the first switch and the third switch, and turn off the second switch and the fourth switch, and
during a fourth operation period, perform a fourth operation comprising controlling to turn off the first switch and the third switch, and turn on the second switch and the fourth switch.

7. The voltage generator of claim 5, wherein the second stage circuit is further configured to repeatedly perform the first operation and the second operation a predetermined number of times in the start-up mode.

8. The voltage generator of claim 7, wherein the second stage circuit generates the first output voltage and applies the first output voltage to the first output node and the second output node in the start-up mode.

9. The voltage generator of claim 4, wherein the first start-up switch comprises a first start-up transistor connected between the first input node and the first node, wherein the first start-up transistor is configured to operate in response to a first start-up switch signal,
wherein the second start-up switch comprises a second start-up transistor connected between the second node and the ground node, wherein the second start-up transistor is configured to operate in response to a second start-up switch signal,
wherein the first switch comprises a first transistor connected between the second input node and the first node, wherein the first transistor is configured to operate in response to a first switch signal,
wherein the second switch comprises a second transistor connected between the first node and the ground node, wherein the second transistor is configured to operate in response to a second switch signal,
wherein the third switch comprises a third transistor connected between the second node and the first output node, wherein the third transistor is configured to operate in response to a third switch signal,
wherein the fourth switch comprises a fourth transistor connected between the second node and the second output node, wherein the fourth transistor is configured to operate in response to a fourth switch signal, and
wherein a level of each of the first start-up switch signal, the second start-up switch signal, the first switch signal, the second switch signal, the third switch signal, and the fourth switch signal switches in response to the second control signal.

10. The voltage generator of claim 9, wherein each of the first start-up transistor, the first transistor, and the second transistor is a first type transistor, and
wherein each of the second start-up transistor, the third transistor, and the fourth transistor is a second type transistor.

11. The voltage generator of claim 10, wherein the first type transistor is a middle voltage (MV) transistor, and the second type transistor is a high voltage (HV) transistor.

12. A method of operating a voltage generator including a first output node and a second output node, the method comprising:
generating, based on a first input voltage, a first output voltage at the first output node and the second output node;
charging a first capacitor with electric charges corresponding to the first input voltage, and charging a second capacitor with electric charges corresponding to a sum of the first input voltage and a second input voltage; and
generating the first output voltage at the first output node and generating a second output voltage at the second output node,
wherein the first output voltage is equal in magnitude to the first input voltage, and opposite in sign to the first input voltage.

13. The method of claim 12, wherein the voltage generator includes:
a first stage circuit including the first output node and the first capacitor; and
a second stage circuit comprising the second output node and the second capacitor, and
wherein the generating the first output voltage is performed by the second stage circuit.

14. The method of claim 13, wherein the second capacitor is connected between a first node and a second node,
wherein the second stage circuit includes a first switch configured to connect the second node and the first output node, and a second switch configured to connect the second node and the second output node, and
wherein the generating the first output voltage at the first output node and the second output node comprises:
charging the second capacitor with electric charges corresponding to the first input voltage;
connecting the first node of the second capacitor with a ground node; and
connecting the second node with the first output node and the second output node.

15. The method of claim 14, further comprising providing the first input voltage at the first node.

16. The method of claim 14, wherein the second stage circuit includes a third switch configured to connect the first node and an input node to which the second input voltage is applied, and a fourth switch configured to connect the first node and the ground node, and
wherein the generating the first output voltage at the first output node and generating the second output voltage at the second output node comprises applying the second input voltage to the first node, and applying, to the second node, a voltage equal in magnitude to the first input voltage and opposite in sign to the first input voltage.

17. The method of claim 16, wherein the generating the first output voltage at the first output node and generating the second output voltage at the second output node further comprises connecting the first node to the ground node and connecting the second node to the second output node.

18. A display driver integrated circuit (IC) (DDI) comprising:
a start-up stage circuit configured to generate, based on a first input voltage, a negative first input voltage;
a first stage circuit configured to generate, based on the first input voltage and the negative first input voltage, a first output voltage; and
a second stage circuit configured to generate a second output voltage based on a second input voltage and the negative first input voltage.

19. The DDI of claim 18, wherein the second stage circuit is further configured to generate the second output voltage further based on the first output voltage.

20. The DDI of claim 19, wherein the first output voltage is equal in magnitude to the first input voltage and opposite in sign to the first input voltage, and
wherein the second output voltage is equal in magnitude to a sum of the first and second input voltages and opposite in sign to the sum.
